(19) United States
(12) Patent Application Publication
(10) Pub. No.: US 2002/0182046 A1
(43) Pub. Date: Dec. 5, 2002

(54) Robotic systems for handling objects

(76) Inventors: Hagen Schempf, Pittsburgh, PA (US); Todd Graham, Pittsburgh, PA (US); Robert Fuchs, Pittsburgh, PA (US); Christian Gasior, Pittsburgh, PA (US)

Correspondence Address: KIRKPATRICK & LOCKHART LLP, 535 SMITHFIELD STREET, PITTSBURGH, PA, 15222, US

(21) Appl. No.: 10/120,333

(22) Filed: Apr. 10, 2002

Related U.S. Application Data
(63) Continuation-in-part of application No. 09/624,752, filed on Jul. 24, 2000.
(60) Provisional application No. 60/145,330, filed on Jul. 23, 1999.

(51) Int. Cl. B66F 1/00

(52) U.S. Cl. 414/623

(57) ABSTRACT

An automated handling system for moving objects from one location to another location is provided with a self-mobile system having a grabber subsystem for grasping objects, including assemblies for movement in four directions, along X, Y and Z axes and through an angle θ. The system also has a translating carriage assembly for moving the grabber subsystem and power supply and drive systems. A sensing device, such as an imager, is provided to determine the geometric position of the objects and to move the grabber subsystem accordingly. Another embodiment of the system is provided as an accessory to a prime mover. It includes an alignment articulation system, a gross advance system, a tine storage system, a loading head system, and pot grabbers. This automated handling system can be used to move plant containers in nurseries from the ground to a trailer bed and/or from a trailer bed to the ground in a variety of container configurations.

### CROSS-REFERENCE TO RELATED APPLICATION

This is a continuation-in-part of co-pending U.S. patent application Ser. No. 09/624,752 filed Jul. 24, 2000, which is a non-provisional application that claims priority under 35 U.S.C. §119 from U.S. patent application Serial No. 60/145,330 filed on Jul. 23, 1999.

### STATEMENT REGARDING FEDERALLY SPONSORED RESEARCH

This invention was made with the United States government support under the following Contract Nos.: 58-1230-8-101 awarded by the United States Department of Agricultural Research Service; NCC5-223 awarded by the National Aeronautics and Space Administration. The United States government has certain rights in the invention.

### BACKGROUND OF THE INVENTION

1. Field of the Invention

The present invention is directed generally to an automated handling system. More particularly, the present invention concerns a robotic system for field container handling.

2. Description of the Invention Background

The nursery industry supplies ornamental crops to the consumer by way of large nurseries, which grow the crop for the landscaping and garden centers where consumers and landscapers acquire their plants for planting in consumer's yards.

Ornamental plants and shrubs account for as much as 10% of the national crop revenue production according to the USDA (includes all crops such as corn, wheat, soybean, etc.). As such, the nursery industry is a multi-billion dollar industry in the US, with more than 2,000 nurseries distributed nationwide. This industry also conforms to the 80/20-rule, in that 80% of all ornamentals are grown by 20% of all growers nationwide. Plants nowadays can be segregated into shrubs and ‘trees’, the former of which is almost exclusively grown in plastic containers (container-growers), with the latter grown in the ground (known as ball-and-burlap or B&B nurseries). Container nurseries represent about 60% of the nursery industry, while the B&B (ball-and-burlap) portion accounts for 40%. As many as 25% of the nurseries in the US are a member of the Horticultural Research Institute (HRI), the research-arm of the American Nursery and Landscape Association (ANLA)—these nurseries alone account for almost half a billion (456×10⁶) containers on the ground today.

Container nurseries come in all shapes and sizes, including mom-and-pop outfits as small as 15 to 30 acres, to hundreds and up to one-thousand acres (many in multiple sites). These nurseries specialize many times on certain varieties of plants, many of them even cloning their own varieties, propagating them, prior to planting them in containers and growing them in the field. Once sufficiently matured, they are then sold by the trailer-load to large distributors or even retail stores (Lowes, Wal-Mart, etc.). Some nurseries specialize exclusively in propagation, while others only grow containers—nurseries might even specialize in growing certain ornamental varieties for a short period of time, before reselling them to other nurseries for further maturing before they are resold to the general public.

Some nurseries do both, namely propagation and container-growing. Container nurseries are located in different growing regions across the US, implying different growing climates and seasons. Plants are grown in growing houses and in the field. In order to maximize the usage of acreage, nurseries in the regions with frost and snow, utilize cold-frames in which they overwinter plants in-between growing seasons.

All container nurseries utilize seasonal (primarily field-workers from Mexico and Central America by way of an INS-approved labor-program) labor in order to accomplish all their tasks throughout the growing seasons. Said labor is getting harder and harder to obtain, requiring continued lobbying-effort in Washington, DC to guarantee exemptions from the INS, involves costly recruiting south of the border, transportation to and from their home-towns and their accommodation once in the US and working on site. In addition, the allure for workers to perform tiring and back-breaking work outdoors is fading when the same labor-pool is being sought for other better-paying and lower-exertion jobs in the US economy such as assembly-, custodial- and other such job-categories.

The majority of labor-intensive tasks in container-nurseries revolves around the handling of containers. Containers are typically re-potted before every growing season, requiring them to be picked up in the field, placed on trailers, brought to a canning-shed where they are taken out of their container and re-potted in a larger container with additional soil (so-called up-shifting), placed on trailers, driven out to the designated bed (outdoor field-area), where they are then placed back on the ground in a variety of different tight/staggered/spaced patterns to allow the plant to grow during the season (they are also fertilized once and continually watered when in the field). Growers in frigid regions also need to take plants out of cold-frames (greenhouses, winter-houses, etc.) and perform the up-shifting and spacing operations. All these operations are extremely labor-intensive and need to be performed in as compressed a time as possible. Competing at that time (typically in early spring) is the continued shipping-schedule, which generates the revenue for the nursery, involving selecting plants, transporting them to the shipping-dock and loading trailers. In the case of nurseries in the ‘snow-belt’, containers that were placed in the field need to be consolidated back into cold-frames, requiring another intensive labor-effort to pick them from the field, transport them via trailer to the cold-frames, and tightly pack them inside the structures to survive the winter-months.

The degree to which growers and laborers perform their jobs efficiently has a large impact on the nursery's profit margin and their ability to optimize plant-growth and -health. Since labor is the prevalent cost in growing ornamentals (up to 60% according to unofficial surveys), the potential for increasing the competitiveness of the industry through automation in order to reduce manpower requirements, or even smooth out the peak labor-requirements, is potentially very large. Based on a discussion with container-growers, it was determined that the first and highest-impact opportunity lies in the automation of the pick-up and drop-off of containers in the field. In other words the tasks encompassing the pick-up of containers sitting out in the field and placement of same onto trailers, and the opposite task of taking them from the trailers and placing them back onto the ground in a variety of different configurations.

Survey results have presented valuable information about labor distribution. Using the data gathered from the surveys, (tasks may be arranged in descending order of the number of laborers required for the task. The resulting list of tasks is shown below:

1. Moving containers to the canning shed from the growing beds and from the growing beds to the canning shed.

2. Moving containers from the growing beds to the staging (shipping) area.

3. Spacing the containers in the growing beds.

4. Moving containers into and out of the overwintering houses.

5. Moving containers for pruning plants.

6. Moving excess containers during spacing operations.

7. Other miscellaneous tasks (including canning, weeding, spraying, and fertilizing).

### SUMMARY OF THE INVENTION

Considering the experiences gathered from field observations and industry-surveys, the present invention addresses the following concerns of growers.

The container-handler may be loaded and unloaded from typical trailers

Since the current trailer-fleet in nurseries is fairly large; it is an advantage to be able to utilize these existing trailers to load/unload containers. Trailers vary in size, ranging from 4′×8′ to 8′×16′. Since these trailers are costly to replace, the system is preferably adaptable to various trailer-sizes at the growers' discretion, with some slight modifications (such as shortened edge-stabilizers along the periphery of the load-platform with cut-out slots) so as to speed up drop-off and pick-up onto/from the trailer.

One embodiment of the container-handler interfaces with common prime movers familiar to the nursery industry

Since container-movement is a fairly short yet intense activity at the beginning and end of the growing season, and large capital investment in nurseries are hard to justify, the embodiment of the invention in the form of an accessory, or add-on tooling system can work with typical nursery prime-mover equipment (tractors, etc.) which many nurseries already have and could thus reuse. This reduces complexity and cost, allowing for the development of several dedicated tools for various tasks.

The system may be operated by one operator

The operator of the prime mover would also operate the accessory handling-system, since they are integral to each other and take advantage of each other's capabilities. A second operator (the one that brings the trailer-train to the growing-bed/cold-frame) may oversee the operation and ensure that containers are not grossly misplaced so as to ensure the handling system works to its maximum efficiency.

The handling system may be used to pick up and drop off most, if not all existing types of containers and multi-container sizes (1 to 5-gallon)

The handling-system design provides for active and manual adaptation of the system to handle a variety of container sizes. Should certain sizes be overly small or large, a separate different sized tool-head may be provided to better optimize operations in the field.

The system handles all forms of container field-configurations, including can-to-can, can-tight and spaced in both pick-up and drop-off

By way of sensory addition and computer-control, the handling system is suited to pick up and drop-off containers in a variety of familiar configurations. This operator may select the type of configuration. Sensory feedback provides the fine-adjustments during operations.

The system may be operated on various surface types, including concrete, compacted dirt, gravel and geotextile (woven fiber-reinforced poly-tarp) and plastic (assuming firm and compacted soil). Since nurseries use a variety of ground cover, ranging from concrete, to gravel to dirt to woven fiber-plastic to 6-mil poly-sheets, the system may be used on these surfaces. The present invention provides an automated handling system that is able to operate on a variety of surfaces such as loose gravel or compacted limestone.

The invention relates to an automated or robotic system to perform the pick-up and drop-off of containers in the field in a more efficient and thus cost-effective manner than practiced in current operations. The system of the present invention is amenable to a large number of growers, from the 10-acre family-farm to the multi-thousand acre conglomerate-farms.

The present invention provides an automated handling system that moves the containers between the field and a trailer. The present invention provides an automated handling apparatus that may be connected to a prime mover as an accessory, or may be a self-mobile unit. The invention may include a grabber assembly having at least one grabber for holding objects to be transferred; a carriage along which the grabber assembly travels; an sensor device for determining the relative geometric positions of the objects to be transferred; a positioning unit for positioning the grabber in up to four degrees of motion in response to the determined geometric positions; and, at least one power source for driving the travel of the grabber assembly and the positioning of the grabber.

The positioning unit may include an X-axis assembly for positioning the grabber along an X-axis; a Y-axis assembly for positioning the grabber along a Y-axis; a Z-axis assembly for positioning the grabber along a Z-axis; and, a pivotal assembly for positioning the grabber at an angle θ.

The X, Y, Z and pivotal assemblies may be interconnected or individually operable. If interconnected, the X-axis assembly may include a first frame, a second frame, one or more rails connected to the second frame and lying on or parallel to an X-axis, wherein the first frame is mounted for travel on the one or more X-axis rails and is operatively connected to the grabber. There may additionally be a third frame, one or more rails connected to the third frame and lying on or parallel to a Y-axis, wherein the second frame is mounted for travel on the one or more Y-axis rails. This embodiment of the positioning unit may further include a fourth frame and the Z-axis assembly may include one or more rails lying on or parallel to a Z-axis, wherein the Z-axis rails are connected to the fourth frame and one or more Z-axis adjusters mounted for travel on the one or more Z-axis rails. The third frame may have first and second ends and may be mounted for pivotal motion about a pivotal axis. The pivotal assembly may include two of said Z-axis rails, two mounting members, one being pivotally connected to the first end of the third frame and the other being pivotally mounted to the second end of the third frame, wherein each of the two Z-axis adjusters are connected to a different mounting member. There may preferably be two cylinders, and more preferably, hydraulic cylinders, wherein each cylinder is linked to a different Z-axis adjuster and each is operable at a different rate and in a different direction for selective non-uniform movement of one or both of the Z-axis adjusters along the Z-axis rails.

Alternatively, the X-axis assembly may comprise one or more rails lying on or parallel to an X-axis, and one or more X-axis adjusters mounted for travel on the one or more X-axis rails. In this embodiment, the X-axis adjusters are operatively connected to the grabber. The Y-axis assembly may comprise one or more rails lying on or parallel to a Y-axis, and one or more Y-axis adjusters mounted for travel on the one or more Y-axis rails. The Y-axis adjusters are operatively connected to the grabbers, directly or through the X-axis assembly. The Z-axis assembly may include one or more rails lying on or parallel to a Z-axis, the Z-axis rails being connected to a frame, and one or more Z-axis adjusters mounted for travel on the one or more Z-axis rails. The Z-axis assembly is operatively connected to the grabber assembly, directly or through the X- or Y-axis assemblies.

The pivotal assembly may comprise a frame having first and second ends and being mounted for pivotal motion about a pivotal axis. The frame is operatively connected to the grabber such that movement of the frame about the pivotal axis is translated to the grabber. The pivotal assembly of this embodiment also may include at least two extension members for moving the frame about the pivotal axis, one member being connected to the first end of the frame and the other extension member being connected to the second end of the frame, and means, such as but not limited to, hydraulic cylinders, for moving one or both of the extension members at one or both of a rate and in a direction that differs from the other of the at least two members.

The carriage of the apparatus may comprise opposing frame sections spaced from each other, wherein each frame section has a guide rail mounted thereon to define a path. The path may be configured to include a first elevated surface, an inclined surface, and a second lower surface. The carriage may also include a drive motor and drive chains powered by the drive motor associated with each guide rail. Each frame section may include an inner frame and an outer frame defining a space therebetween. The carriage may further include a drive rod spanning the space between opposing frame sections, wherein the drive motor is operatively connected to the drive rod, and a plurality of chain sprockets mounted in the space between the inner and outer frame sections along the length of each path for engagement with the drive chains. A channel may be provided for housing connections to the power supply.

The grabber assembly may include opposing travel arms, each having forward ends and rear ends, roller members mounted on each travel arm and driven by the drive chain of the carrier for travel along the path thereof, a grabber rail positioned proximate to the forward ends of the travel arms, and a plurality of grabbers mounted on the grabber rail. The grabbers have an open position and a closed position for grasping objects to be transferred, wherein the grabbers are operatively connected to the power source for affecting the open or the closed positions.

The sensor device, which may be an imaging device, such as a stereo camera or a two-dimensional laser scanner, is preferably mounted on a forward end of the apparatus for capturing the orientation of objects to be transferred along X, Y and Z axes and at an angle θ relative to a selected frame of reference. The sensor device receives positional signals from the objects and transfers such signals to a processing unit for determination of the geometric positions of the sensed objects and the movement of the positioning unit necessary for alignment of the grabbers with the objects.

In the self-mobile embodiment, the system may comprise a vehicle having a power source, a drive subsystem, a grabber subsystem for grasping containers, a carriage subsystem for moving the grabber subsystem, a sensing subsystem for determining the geometric orientation of the objects to be moved and a conveyor subsystem for transferring the objects via the grabber subsystem from one location to another.

The accessory embodiment of the present invention provides an automated handling system comprising an alignment articulation system, a gross-advance system, a tine storage member, a loading head and pot grabbers.

The accessory embodiment comprises a frame, a grabber head assembly mounted on a telescoping arm assembly and a conveyance system for transferring the containers from the grabber head assembly to a trailer bed.

The grabber head assembly comprises a plurality of grabber members that grip the containers, for example by means of hydraulic actuation. Each of the grabber members in this embodiment, may be a semi-circular, or arcuate member defining an opening that receives a container and engages the circumference of the container and not the lip of the container, thus preventing the possibility of damaging the foliage of the plant.

Other details, objects and advantages of the present invention will become more apparent with the following description of the present invention.

### BRIEF DESCRIPTION OF THE SEVERAL VIEWS OF THE DRAWINGS

For the present invention to be readily understood and practiced, preferred embodiments will be described in conjunction with the following figures wherein:

FIG. 1 is a chart of the total number of different container sizes as a percentage of the total number of containers;

FIG. 2 is a front perspective view of a self-mobile, drivable embodiment of the container-handling vehicle of the present invention;

FIG. 3 is a rear perspective view of the vehicle of FIG. 2;

FIG. 4 is a top plan view of the vehicle of FIG. 2;

FIG. 5 is a front-end view of the vehicle of FIG. 2;

FIG. 6 is a view of the left side of the vehicle as shown in FIG. 3;

FIG. 7 is a view of the right side of the vehicle as shown in FIG. 3;

FIG. 8 is a perspective view of the grabber system of the vehicle of FIG. 2;

FIGS. 9 A & B are rear perspective views of the grabber system of FIG. 8, showing left and right perspectives of the positioning unit;

FIG. 10 is a top plan view of the grabber system of FIG. 8;

FIG. 11 is a front-end view of the grabber system of FIG. 8;

FIG. 12 is a perspective view of the frame for the vehicle of FIG. 2;

FIG. 13 is a top plan view of the grabber system of FIG. 8 mounted for travel on the carrier assembly of the vehicle of FIG. 2;

FIG. 14 is a perspective view showing the grabber system in an elevated position on the carrier assembly;

FIG. 15 is a perspective view showing the grabber system in a lowered position on the carrier assembly;

FIG. 16 is a top plan view of the conveyor system of the vehicle of FIG. 2;

FIG. 17 is a side view of the conveyor of FIG. 16;

FIGS. 18-20 are views of the indexing apparatus of the container-handling vehicle of FIG. 2;

FIG. 21 is graph showing experimental data for the grabber and scanner of the embodiment of the invention shown in FIG. 2;

FIG. 22 is a schematic showing the high-level computer architecture for the vehicle of FIG. 2;

FIG. 23 is a flow chart showing the navigation approach of the vehicle of FIG. 2;

FIG. 24 is a schematic of the software architecture used in the vehicle of FIG. 2;

FIG. 25 is a diagram of the sensor controls for the vehicle of FIG. 2;

FIG. 26 is a diagram of the process for picking up containers with the vehicle of the present invention;

FIG. 27 is a diagram of the process for picking up containers using the vehicle of the present invention;

FIG. 28 is a diagram of the process for placing containers using the vehicle of the present invention.

FIG. 29 is a block diagram of the container handling systems of an alternative embodiment of the present invention;

FIG. 30 illustrates the tine-storage system with a container of an alternative embodiment of the present invention;

FIG. 31 A & B illustrate top and side views of a tine and grabber loading head system interaction of an alternative embodiment of the present invention;

FIG. 32 illustrates the tine and grabber loading head system interaction of an alternative embodiment of the present invention where the container is flipped onto a continuous chain conveyor;

FIG. 33 illustrates an alternative embodiment of the present invention wherein the loading head system has a doubly actuated parallel linkage mechanism;

FIG. 34 illustrates the loading head system having a cam and linear actuator for grab, lift, transport and lower of an alternative embodiment of the present invention;

FIG. 35 A & B illustrates the loading head system of an alternative embodiment of the present invention having a four bar cam linkage to lift up and over;

FIG. 36 illustrates the loading head system of an alternative embodiment of the present invention having a Ferris wheel multi-pot cam chain grabber;

FIG. 37 illustrates a container grabber of an alternative embodiment of the present invention having rubber fingers on tines acting on draft;

FIG. 38 illustrates a container grabber of an alternative embodiment of the present invention having a sidewall inflatable tine bellows;

FIG. 39 illustrates a container grabber of an alternative embodiment of the present invention having a cam actuated lifting tine fingers;

FIG. 40 illustrates a container grabber of an alternative embodiment of the present invention having three-point support lifter claw;

FIG. 41 illustrates a container grabber of an alternative embodiment of the present invention having a double lip pot with stiff brush tine edge;

FIG. 42 illustrates a container grabber of an alternative embodiment of the present invention having a rubber fingers on tines acting on draft;

FIG. 43 illustrates a container grabber of an alternative embodiment of the present invention having circular support finger claws;

FIG. 44 illustrates a container grabber of an alternative embodiment of the present invention having a container lift support and clamping claw;

FIG. 45 illustrates a container grabber of an alternative embodiment of the present invention having a lay back support clamp;

FIG. 46 is an alternative embodiment of a grabber system of the present invention having rubberized fixed angle tine;

FIG. 47 is another embodiment of the grabber system of the present invention having circular half inclined lip support pickup tines;

FIG. 48 is yet another embodiment of the grabber system of the present invention having inclined semi-circular support ring grabbers;

FIG. 49 is another embodiment of the grabber system of the present invention having passively rotating semi-circular support pickup grabbers;

FIG. 50 is yet another embodiment of the grabber system of the present invention having a lip pinching grabber system;

FIG. 51 is another embodiment of the grabber system of the present invention having rotating butterfly pinch grabber system, shown in the closed position;

FIG. 52 is yet another embodiment of the grabber system of the present invention having a rotating butterfly pinch grabber system wherein the grabber system is in the open position;

FIG. 53 illustrates the can-to-can grabber head utilizing the butterfly system wherein the grabber heads are in the closed position;

FIG. 54 is a detailed view of the brush tine chain system;

FIG. 55 is a view of an embodiment of the invention having a plurality of containers on the continuous conveyor of FIG. 30;

FIGS. 56 illustrates an embodiment of the present invention being used with different cold frame design;

FIG. 57 illustrates different configurations for placing the plant containers;

FIG. 58 illustrates can tight modified configuration for placing the plant containers;

FIG. 59a is a perspective view of another embodiment of the container handling system of the present invention, wherein the sliding conveyor is in the inoperative position and the trailer conveyor is shown disconnected from the frame for clarity;

FIG. 59b is a perspective view of the embodiment of the container handling system shown in FIG. 59a, wherein the sliding conveyor is in the operative position;

FIG. 60 is a top view of the container handling system of the present invention shown in FIG. 59;

FIG. 61 is side view of the container handling system of the present invention shown in FIG. 59;

FIG. 62 is a perspective view of the telescoping arm assembly of the container handling system of the present invention shown in FIG. 59;

FIG. 63 is a side view of the telescoping arm assembly shown in FIG. 62;

FIG. 64 is a sectional view of the telescoping arm assembly shown in FIG. 63 taken along line A-A;

FIG. 65 is top view of the grabber heads; and, FIG. 66 shows the accessory embodiment of the handling system of the present invention attached to a prime mover.

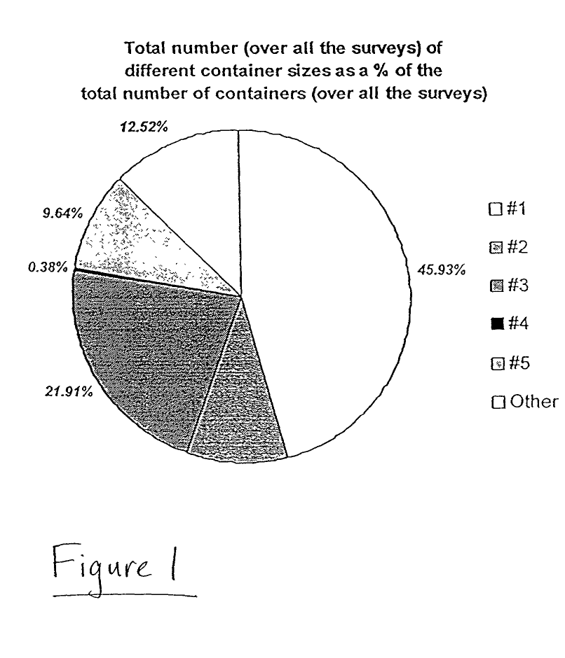

### DETAILED DESCRIPTION OF THE INVENTION

The present invention will be described below in terms of several embodiments of an automated container handling system and related methods for handling containers. It should be noted that describing the present invention in terms of an automated container handling system is for illustrative purposes and the advantages of the present invention may be realized using other structures and technologies that have a need for such apparatuses and methods for handling of objects.

It is to be further understood that the figures and descriptons of the present invention have been simplified to illustrate elements that are relevant for a clear understanding of the present invention, while eliminating, for purposes of clarity, other elements and/or descriptions thereof found in an automated handling system. Those of ordinary skill in the art will recognize that other elements may be desirable in order to implement the present invention. However, because such elements are well known in the art, and because they do not facilitate a better understanding of the present invention, a discussion of such elements is not provided herein.

Systems were developed having a set of clearly identifiable components. Two approaches have been developed. The components of the handling system may be incorporated into a self-mobile, powered vehicle or removably attached as an accessory to a distinct locomotion-platform, such as a primary mover. Each embodiment of the handling system will be described herein.

Self-Mobile Embodiment of the Handling System

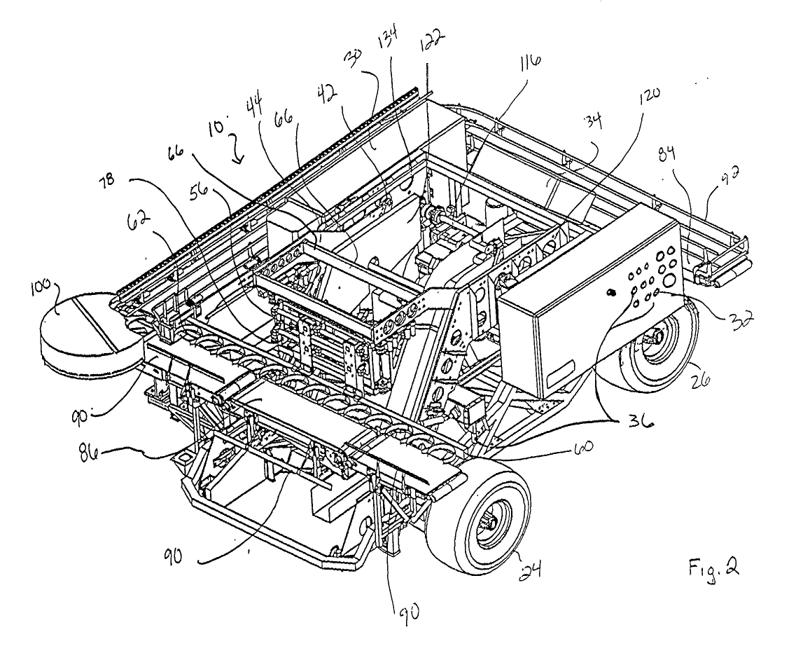

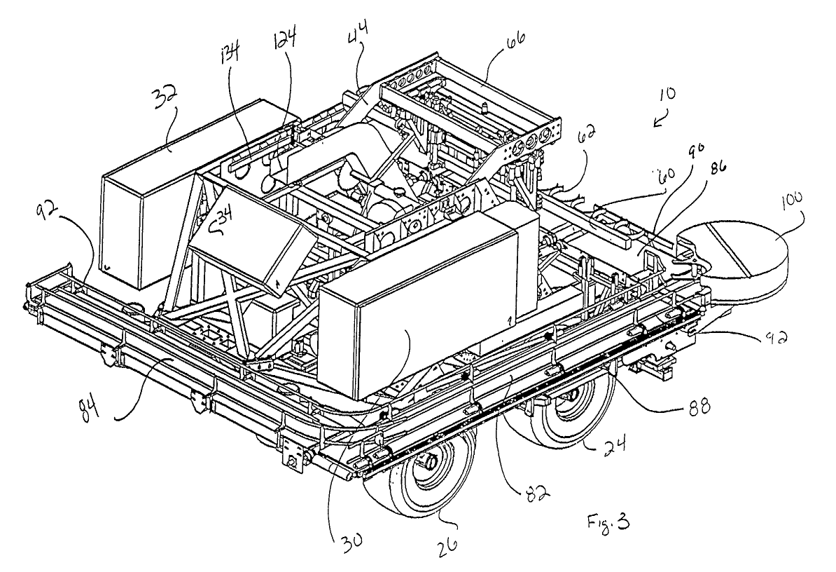

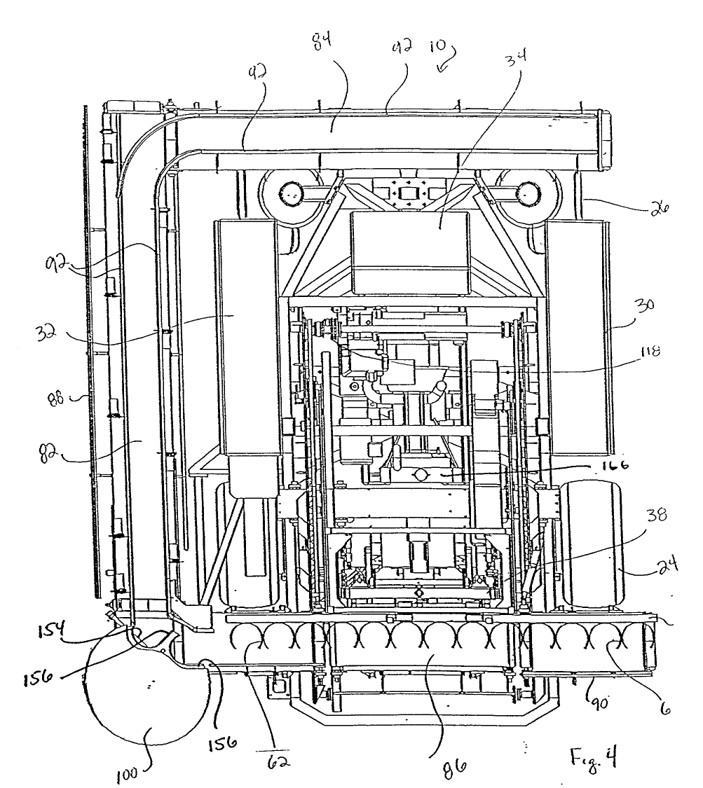

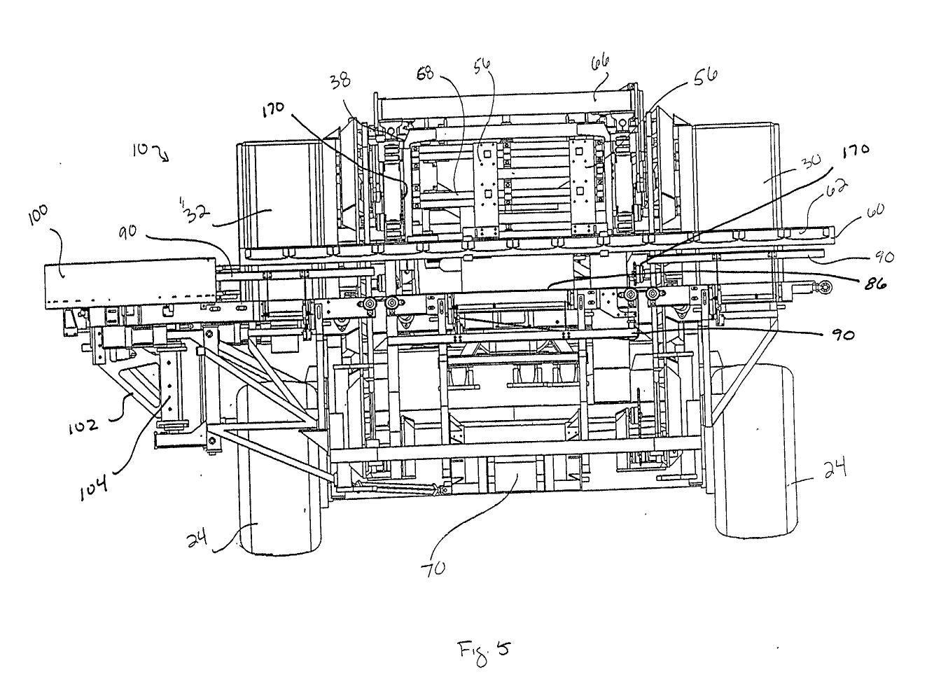

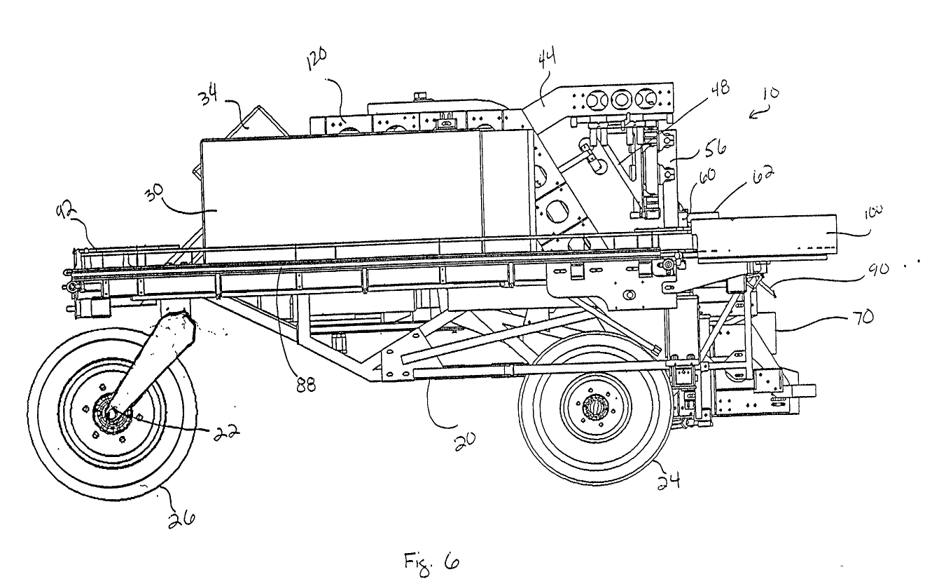

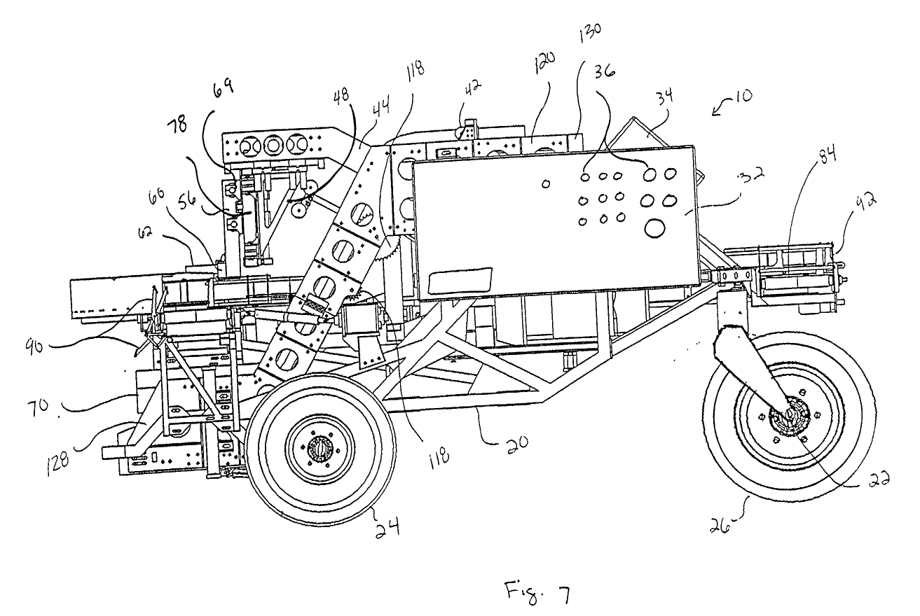

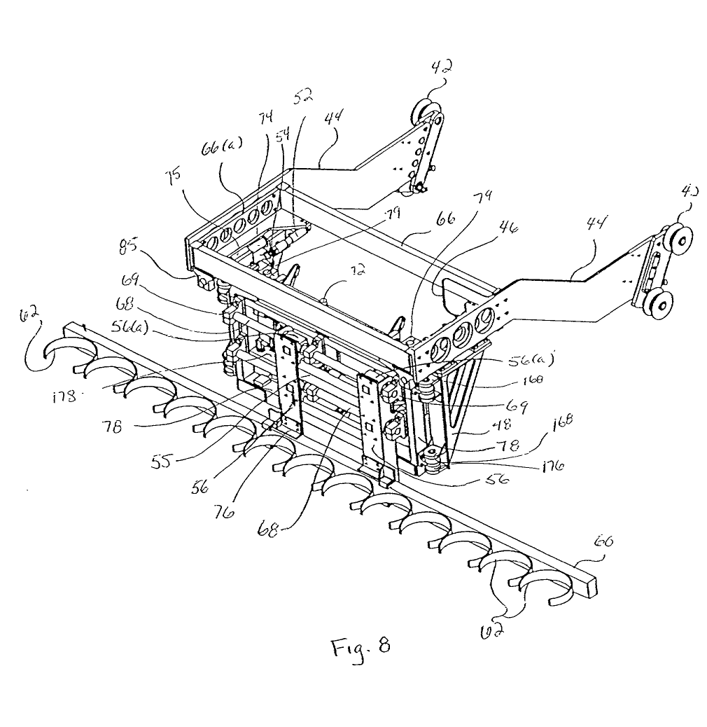

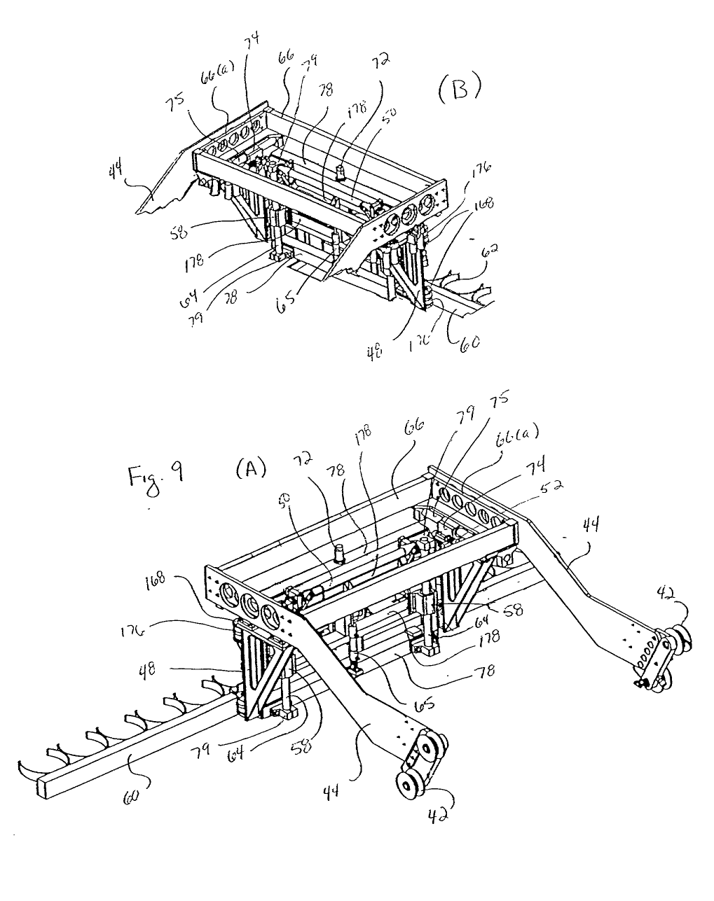

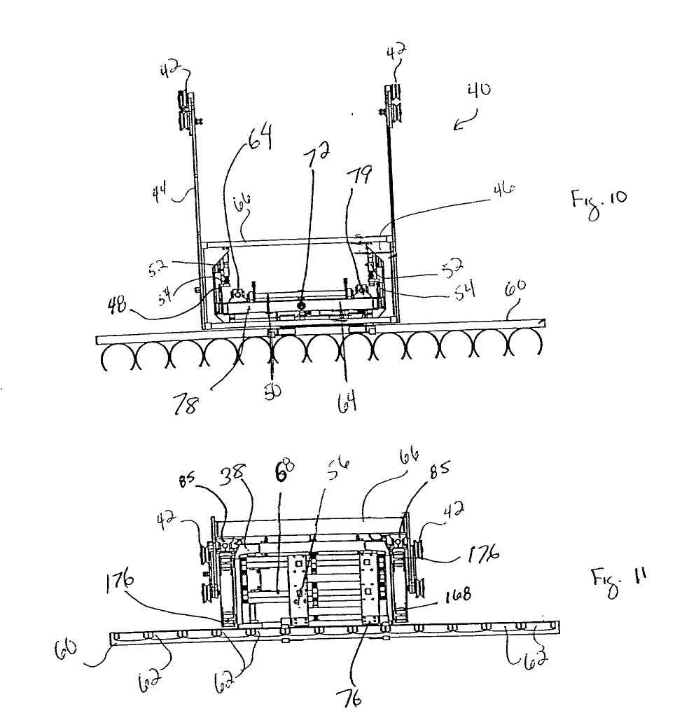

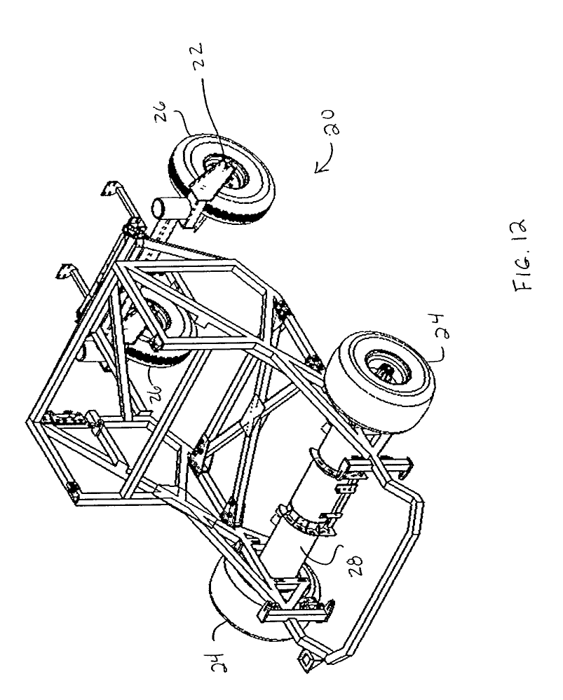

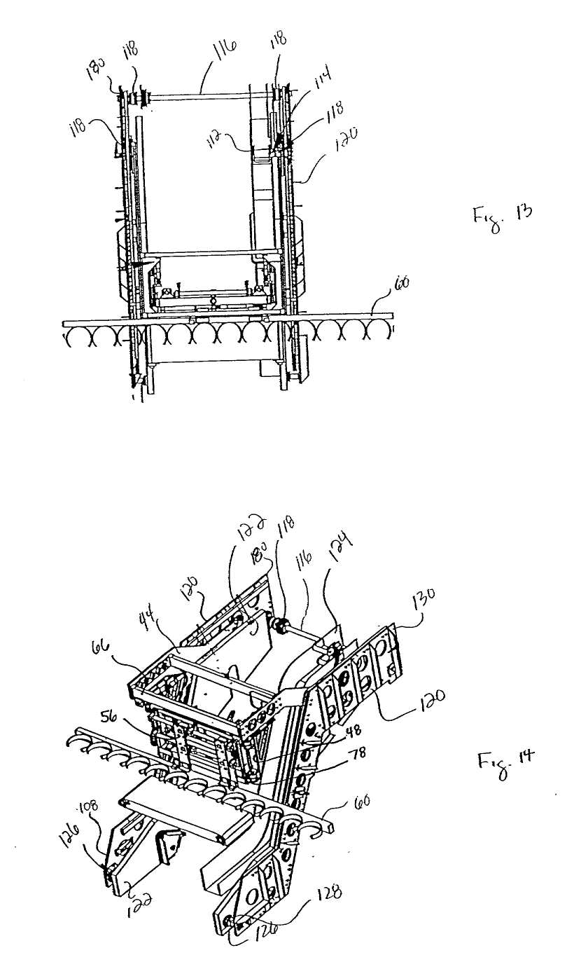

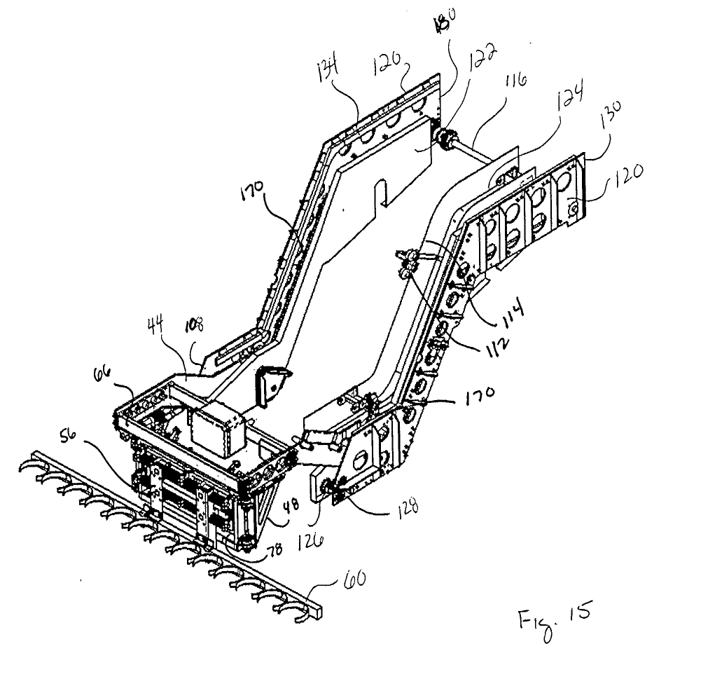

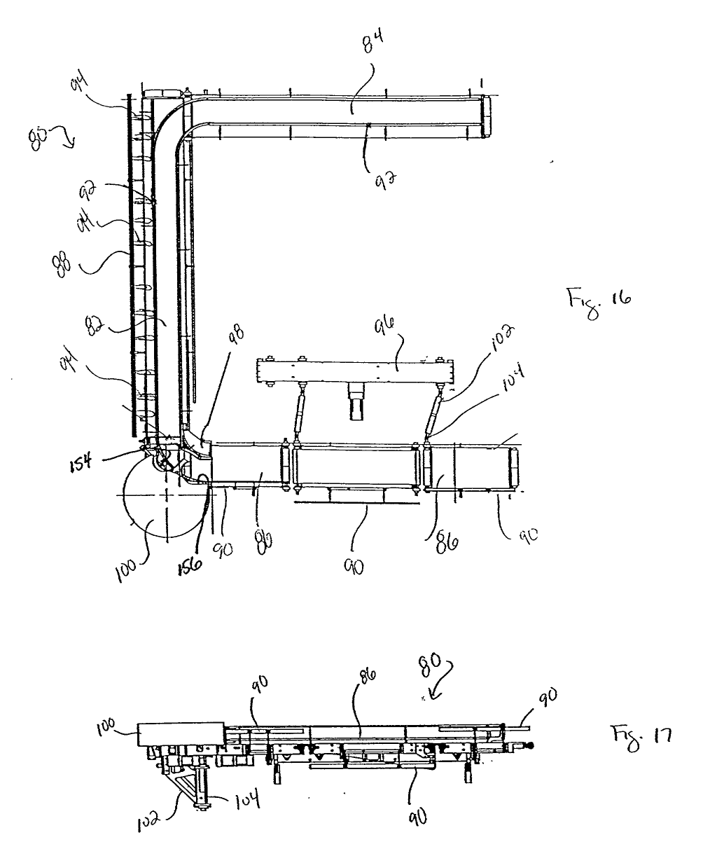

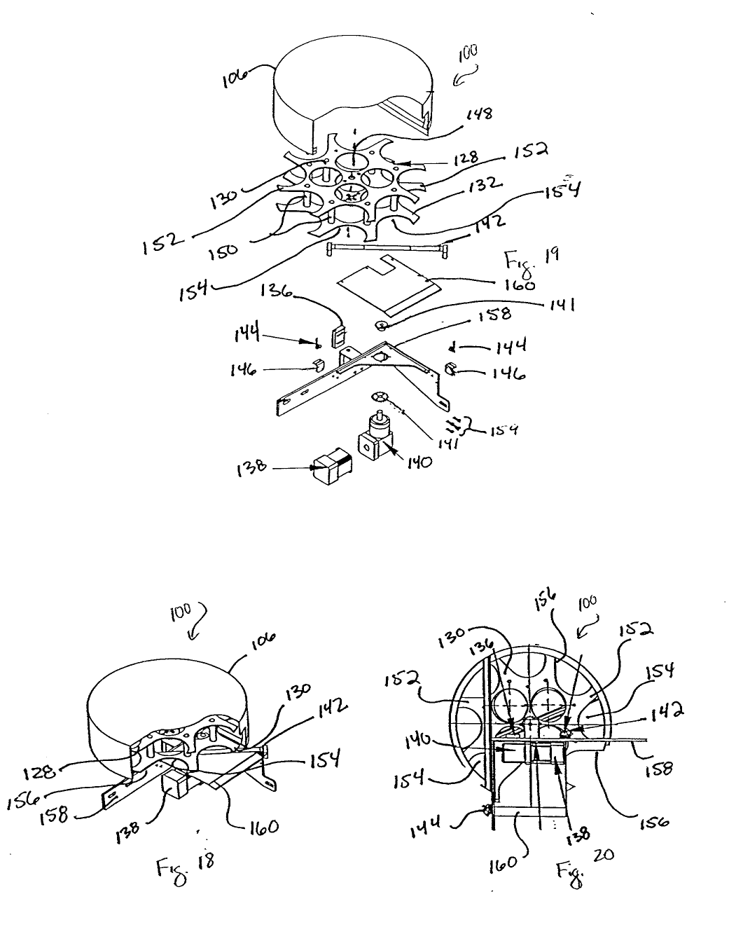

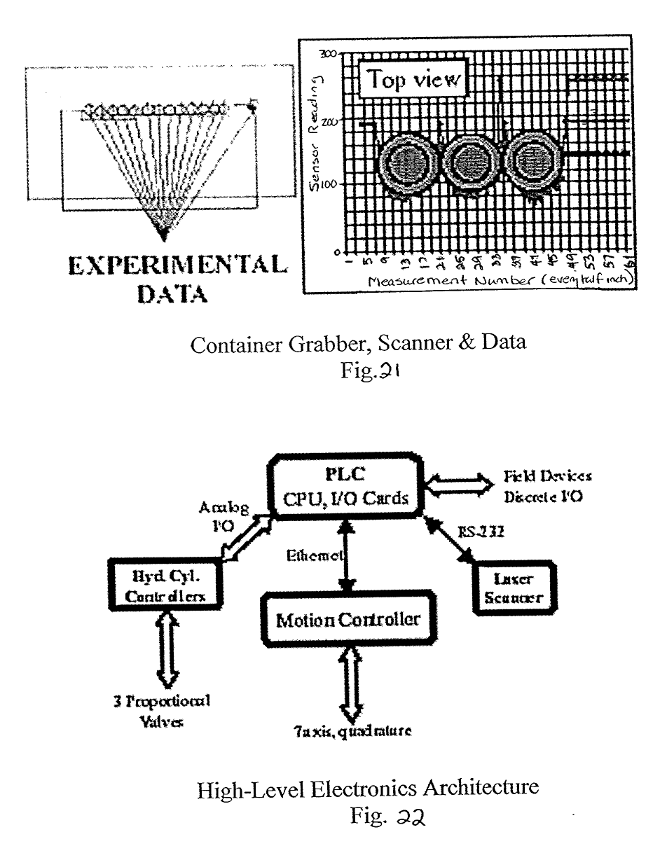

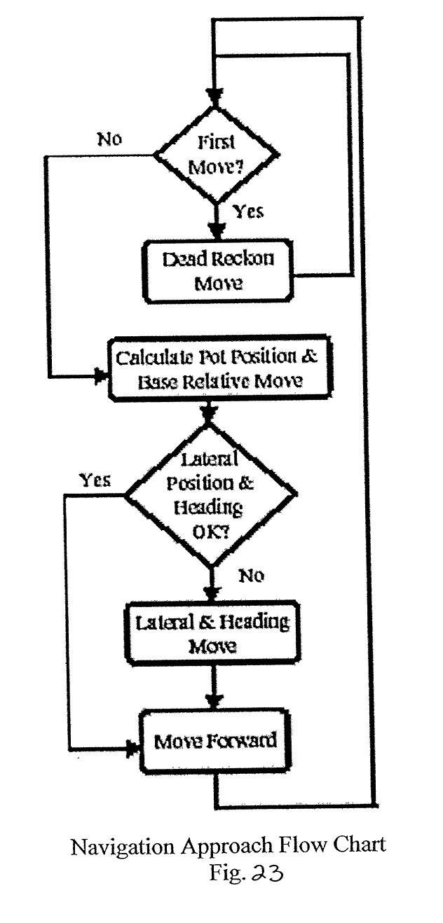

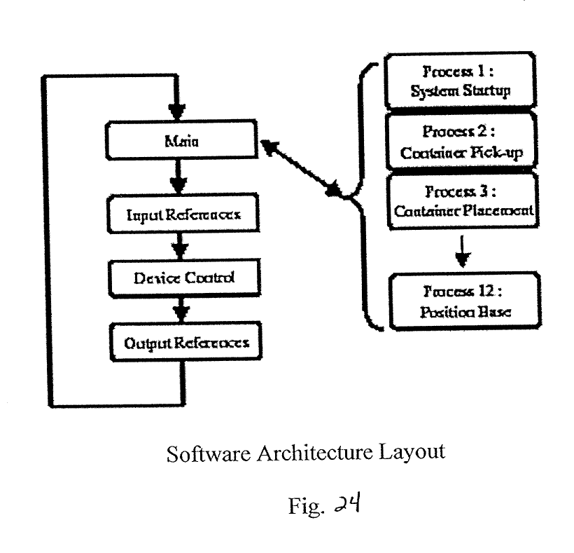

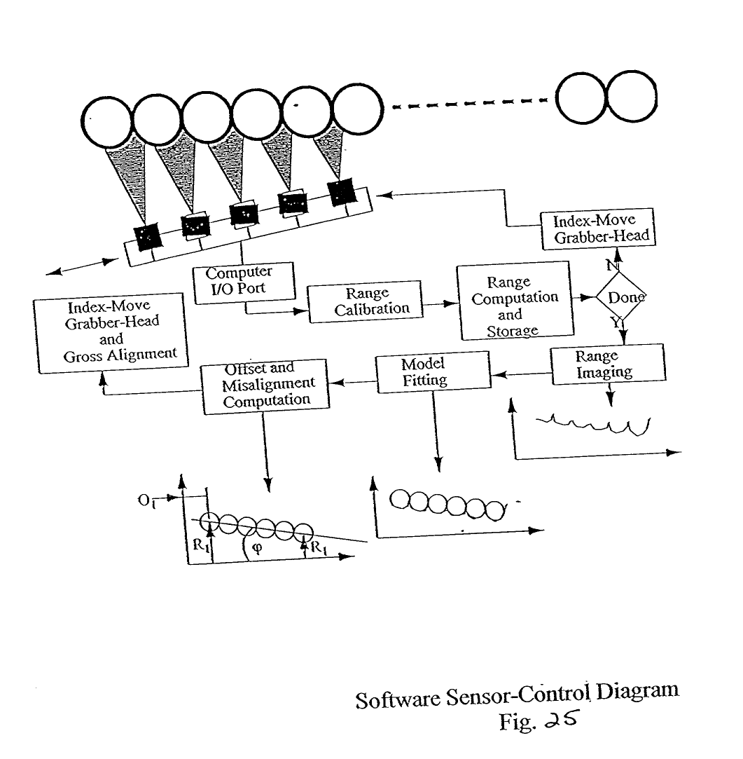

The self-mobile embodiment of the handling system of the present invention is shown in FIGS. 2-20. This design was developed for automated field-container handling. It is powered by an IC engine, perceives containers through a laser range finder, is controlled through an on-board programmable logic control computer, and is actuated through a set of electro-hydraulic and electromechanical actuation systems. The system relies on an electrically driven, differentially steered, forward drive train with rear floating rocker arm with passive casters. The overall frame-structure supports an IC engine powering a generator, providing all electrical power and driving a small hydraulic pump.

Containers are picked up and dropped onto the ground row by-row using a hydraulically-powered squeeze-pinch grabber-arm 60 with a plurality of grabber heads 62 (for example, for a 7-foot wide bed), which is fine positioned in four degrees of motion by a X, Y, Z, θ-positioning unit 38 sitting on a curvilinear carriage assembly 110 to provide for extension, retraction, raising lowering and rotation. Conveyors 82, 84, 86 rapidly move containers off to the side (preferably, onto a waiting flat bed trailer 14). The operation is run in reverse for setting down and spacing out containers.

All driving and grabber-alignment functions are based on geometric capture of container positions. For example, an imaging scanner may be mounted on the front of the vehicle to capture two-dimensional (2D) data of the relative positions of the containers on the ground or on a trailer. For example, a front-mounted all weather SICK® laser scanner 70 may be used. The positioning unit controls the grabbing of the containers in response to the scanned geometry.

The overall system can thus be seen to consist of several major subsystems, including (i) a frame 20, (ii) drive and steer subsystems, (iii) container grabber, handler and transfer subsystems and, (iv) power and control subsystems. The roles and interconnections of each of the above subsystems can be generally described as detailed below:

An embodiment of the self-mobile handling system is shown as an independent vehicle in FIGS. 2-7. It represents a highly maneuverable combine-based front wheel skid-steer-driven machine. In the embodiment shown, the vehicle 10 includes a welded frame 20, powered by an on-board gas engine that converts gasoline energy to electrical energy, which is then used to power other subsystems. The vehicle also includes a grabber subsystem 40, a translating carriage assembly 110, a conveyor subsystem 80, power supply and control subsystems and a drive subsystem.

The frame 20, shown in FIG. 12, consists of a welded tubular structure, upon which rest the IC power plant, hydraulic drive system, power and control electronics, as well as the container grabbing and handling subsystems and associated conveyors. There are two electrically driven front wheels 24 mounted on opposing ends of a differential drive tube 28, and two rear wheels casters. The front wheels 24 have locking hubs to disconnect the wheels from the drive train in order to allow the entire machine to be towed. The rear axle system includes a rocker-boagie arm axle with dual offset casters 22.

The main power source for the system 10 can be an internal combustion-engine 166 (See FIG. 4) mounted on the frame, providing both electrical power via a generator, and hydraulic power through a direct-coupled pump. The power from the engine 166 is regulated through a dedicated power cabinet 30, while the electronics and controls for the programmable logic control (PLC), the motor amplifiers and the relays and valves are housed in a separate control compartment 32. Fuel tanks and hydraulic cooling radiators are mounted on the frame as well. Rear compartment 34 houses the hydraulics controls.

The locomotion subsystem may include a front-mounted drive-tube 28 with two DC motor driven gearboxes on either end, coupled to low-pressure turf-tires 24 by way of a manual splined hub (allowing high-speed towing by decoupling the drive-train from the wheels). The drive and steering for the vehicle 10 is achieved by driving the two front wheels 24 in a differential manner. Drive and steering amplifiers control the front drive wheels and are located in the compartment 32. The system is thus capable of an in-place turn about the center of the front axle, which is useful for operating within the plant-bed to minimize wasted motions and optimally combine gross (vehicle-base) and fine (grabber-head-detailed next) motions.

The grabber subsystem 40, shown in FIGS. 8-11, includes parallel extension arms 44, rollers 42, and a geometric positioning unit 38 having a grabber rail 60 with a plurality of grabber heads 62 mounted thereon. In the embodiment shown, there are two pairs of chain driven rollers 42, one pair mounted on the rear end of each extension arm 44, for travel along a guided path of the translating carriage assembly 110, which will be described in more detail below.

The positioning unit 38 provides four degrees of motion for fine control of the grabber rail 60. Unit 38 includes (1) an X-axis assembly for effecting movement of the grabber rail 60 along the X-axis from left to right and vice versa, (2) a Y-axis assembly for effecting movement of the grabber rail 60 along the Y-axis up and down and vice versa, (3) a Z-axis assembly for extending and retracting the grabber rail 60 along the Z-axis, and (4) a pivotal assembly for effecting movement of the grabber rail 60 through an angle θ. In the embodiment shown, all movement of the geometric positioning unit 38 assemblies is hydraulically actuated. A hydraulic line 46 is shown in FIGS. 8 and 10. Although other power sources would work as well, hydraulic actuation is favored because the power to weight ratio is greater than it would be with a different power source. For example, the positioning unit 38 assemblies may be electrically actuated, but the components needed for an electronic power source exhibits a lower power to weight ratio than does the hydraulic power source.

Referring to FIGS. 8 and 11, the X-axis assembly shown in FIGS. 8 and 11 includes a first frame of actuation 56 having connecting rails 55 and two horizontal adjusters 56(a) mounted thereon. Brackets 76 join the frame 56 to grabber rail 60. Horizontal adjusters 56(a) ride from left to right and vice versa along horizontal rods 68. Rods 68 are mounted with end mounts 69 to the sides of a second frame 178.

Referring to FIGS. 9 A & B, the Y-axis assembly includes the second frame of actuation 178, vertical adjusters 58 and vertical rods 64. Vertical adjustors 58 are connected to frame 178. The adjusters 58 ride up and down along vertical rods 64. The rods 64 are mounted with end mounts 79 to the top and bottom rails of a third frame of actuation 78. A shaft 50 spans the distance between rods 64 to maintain the alignment between them so that the rods move in unison, and the frame resists buckling. A hydraulic cylinder 65 is also mounted at one end to the bottom rail of third frame 78 and to the top rail of second frame 178. Actuation of cylinder 65 moves second frame 178 up and down along the Y-axis. Movement of the second frame 178 moves the vertical adjusters 58, which are attached to second frame 178, along rods 64 (along the Y-axis). First frame 56, which is mounted by rods 68 to second frame 178 is thus also moved, thereby effecting coordinated movement of grabber rail 60 along the X and Y-axes.

The Z-axis assembly and the pivotal assembly share the third frame of actuation 78, extension adjusters 74, extension rods 75 and hydraulic cylinders 52. Referring to the embodiment of FIGS. 8-10, two extension rods 75 are provided, one being positioned beneath each side 66(a) of a fourth frame 66. Each rod 75 is connected with end mounts 85 to the front and rear rails of frame 66. Two extension adjusters 74 are provided; one extension adjuster 74 being mounted to the top of a different one of the extension mounts 48. Hydraulic cylinders 52 are each connected at one end to frame 66 and at the other end to a different one of the adjusters 74. Each extension mount 48 is pivotally connected to one of the sides of third frame 78 by hinges 168 and bearings 176. Rods 75 pass through openings in extension adjusters 74, thereby allowing adjusters 74 to ride forward or backward along rods 75 in response to actuation by cylinders 52. A linkage assembly 54 operatively connects the piston end of a cylinder 52 to one extension adjuster 74.

Extension and retraction of grabber rail 60 along the Z-axis is effected by coordinated, uniform activation of cylinders 52 to move each extension adjuster 74 along its associated extension rod 75 at substantially the same rate in the same direction. Actuation of the cylinders 52 moves adjusters 74 forward or backward along rod 75, moving extension mounts 48 with them. The connection between the extension mounts 48 and frame 78 through hinges 168 and bearings 176 causes the extension or retraction of the grabber rail 60, which as shown, is attached to frame 78 through frames 178 and 56.

Movement of the grabber rail 60 through an angle θ about pivot rod 72 is effected by non-uniform actuation of cylinders 52. By extending or retracting the cylinders 52 at different relative rates and/or directions, or by extending or retracting one while keeping the other stationary, one side of frame 78 moves forward and one side moves back or remains in place, causing frame 78 to pivot about pivot rod 72. The position of grabber rail 60 may thereby be adjusted at a desired angle θ. Hinges 168 and bearings 176 at the forward ends of extension mounts 48 allow the third frame 78 to pivot. The bearings may advantageously be made of an elastomeric material to provide better maneuverability of the frame 78 while pivoting.

The grabber rail 60 includes a plurality of hydraulically actuated individual grabber heads 62. Each grabber head 62 is configured to receive a container. The grabber heads 62, in the embodiment shown in FIGS. 8 and 65, each have an open position for receiving and releasing containers, and a closed position for grasping and holding containers while being moved. Actuation of the grabber heads is hydraulically powered in the embodiment shown, but may be by any suitable power source. Referring to FIG. 65, the grabber heads have two curved sections that together form an arcuate member 280. The two curved sections open outwardly to receive or release containers, and close inwardly to grasp containers. The grabber subsystem may include several interchangeable sets of different sized grabber heads 62 or 280 for mounting on the grabber rail 60. Each set is configured for handling different standard sizes of containers.

The method used to grab containers reliably, without requiring any specialized container design, may be carried out using an articulated double half-moon friction-clamp design. The containers are grabbed by means of a pressure grab through the clamping action of hydraulically actuated grabber heads 62. By ganging these pinching pressure-grabbers 62 along an actuated rail 60 (push/pull linkages to open/close grabbers), a whole row of containers can be grabbed at once and moved around. The bar-mounted pinch-grabbers 62 are mounted to the articulated X, Y, Z and θ-positioning unit 38 that rides on the translating carriage assembly 110.

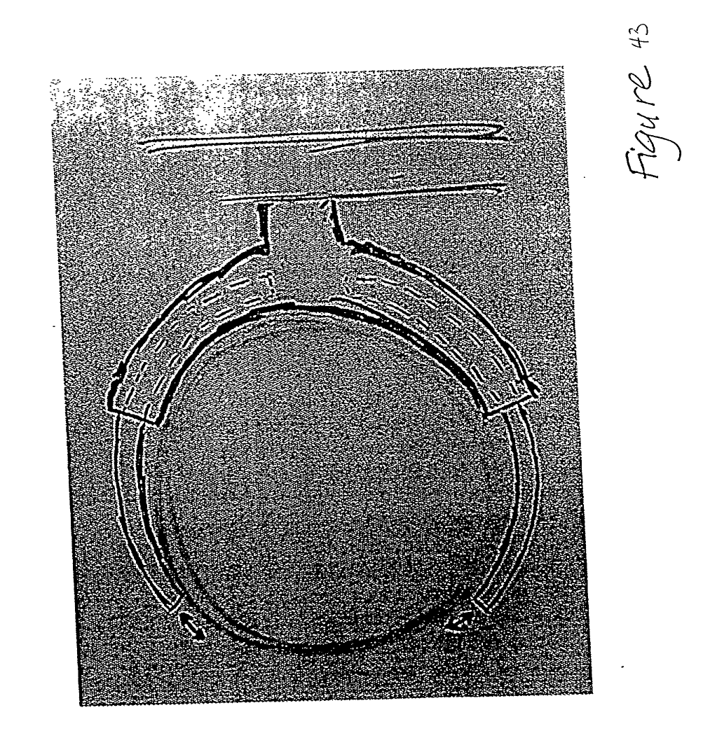

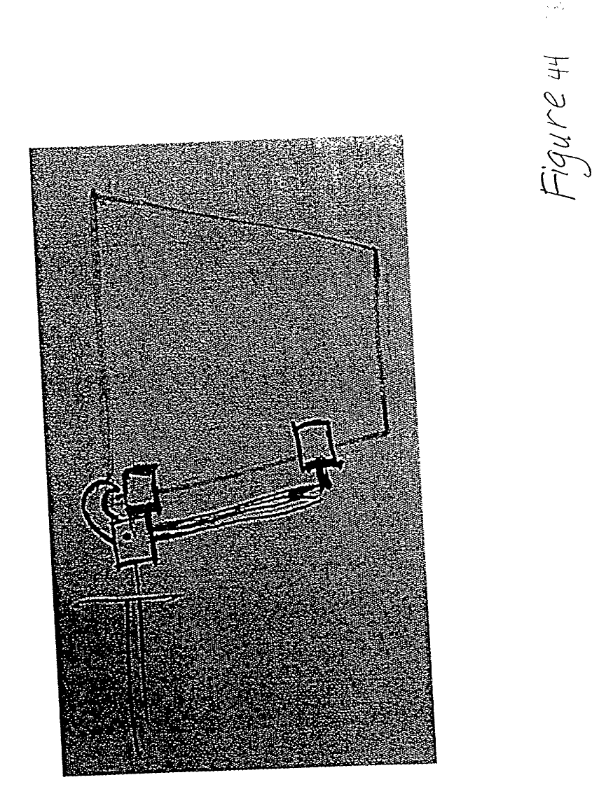

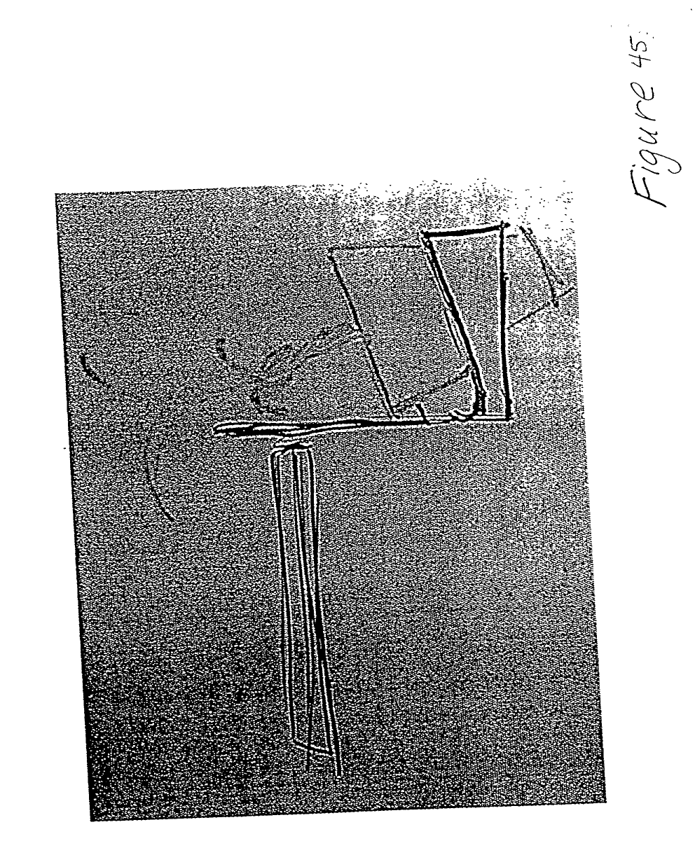

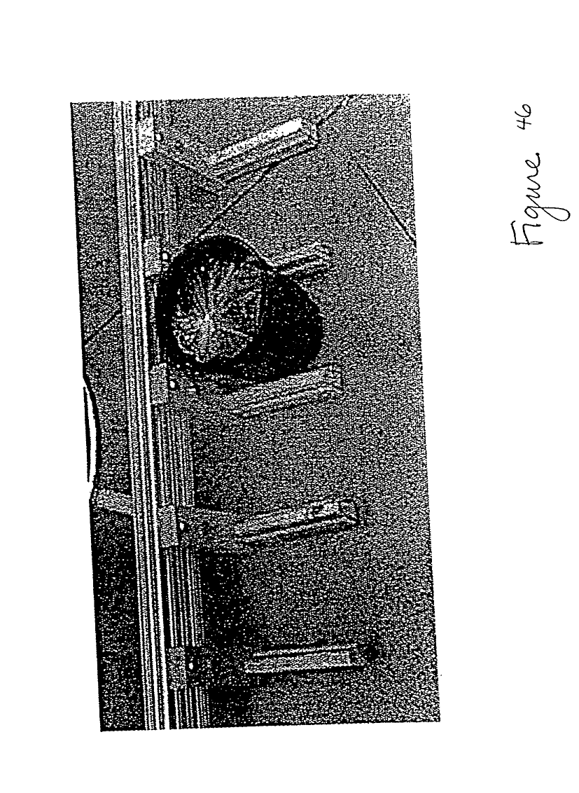

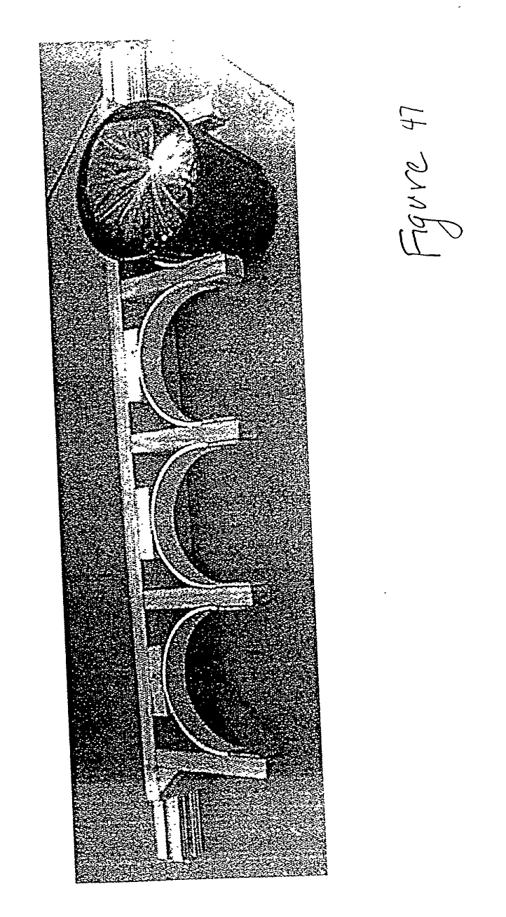

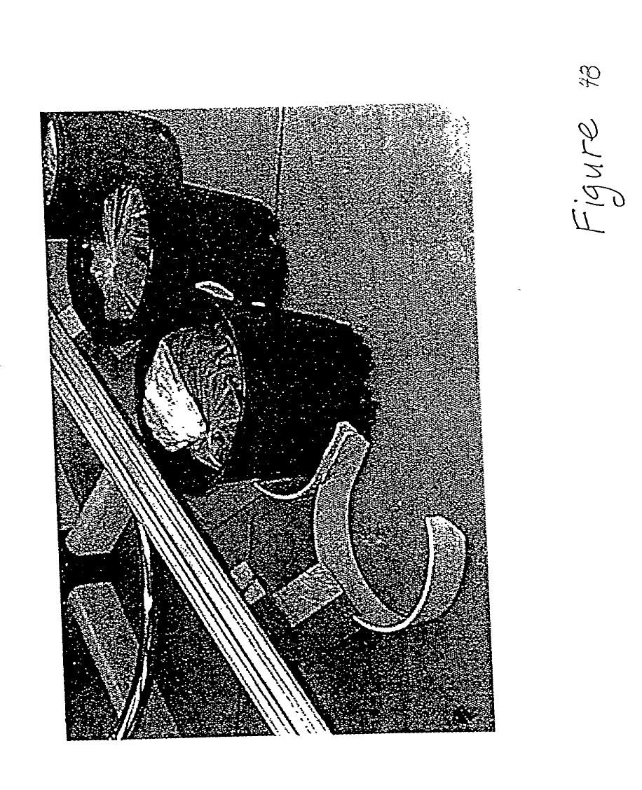

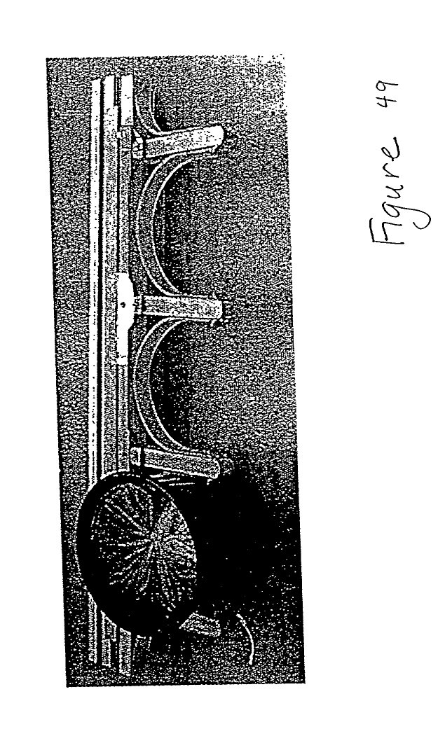

Although the generally circular, or arcuate, shape of the grabber heads is shown for the self-mobile embodiment of the invention, other methods of grabbing the containers may be used, such as those shown in FIGS. 39-51 and described later herein.

The grabber subsystem 40 is mounted for travel on the translating carriage assembly 110. Referring to FIGS. 13-15, carriage assembly 110 includes outer frame sections 120 and inner frame sections 122. Frame sections 120 are structured to have an upper straight section, an inclined, or sloped section and a lower straight section. The configurations of the sections serve as a guide for the travel of grabber subsystem 40 forward and down, or up and back. The embodiment shown achieves those paths by providing an upper relatively horizontal path, followed by an inclined, or sloped path, to a lower generally horizontal path. Upper and lower roller guides 134 are mounted along the length of each outer frame section 120 and follow the path described.

Alternatively, the frame sections 120 may be any suitable shape, but the guide rails may be configured to define a path generally as described to guide the travel of the grabber assembly forward and down, and up and back, to and away from the containers, respectively, as desired.

FIGS. 13 and 14 show the grabber subsystem in a fully retracted positioned on the carriage assembly, with rollers 42 near the end 180 of frame 120. FIG. 15 shows the grabber subsystem in an extended position, with the rollers 42 positioned at the lower surface of frame 120 near end 108.

Drive rod 116 spans the distance between the rear ends of frame sections 120. Chain sprockets 118 are mounted on each end of drive rod 116 adjacent to the ends of outer frame sections 120. Additional chain sprockets 118 are positioned at intervals along outer frame section 120 from the rear end 180 toward the front end 108. Chains 170 are mounted on the sprockets 118. A motor (not shown) is provided to transfer motion to drive rod 116, and thus to sprockets 118, which in turn drive chains 170. Rollers 42 of the grabber subsystem are driven by the chains 170, along the path of the roller guide rails 134 of the carriage assembly 110 to effect movement of the grabber subsystem forward and down, or up and back, as desired. Stop brackets 126 are positioned between the front ends 128 of outer and inner frame Sections 120, 122, respectively to limit the travel of roller pairs 42.

The electrical and hydraulic lines are carried in an e-chain guide 124. Chain mounts 112 and 114 having roller attachments are positioned in track 124 to keep the electrical and hydraulic connections from being tangled as the grabber subsystem travels along the carriage.

The conveyor subsystem is shown independently in FIGS. 16-17 and as embodied in the vehicle in FIGS. 2-4 and 6. The conveyor subsystem 80 includes side transfer conveyor 82, rear conveyor 84 and front conveyor 86. Guard rails 92 are positioned on each side of rear and side conveyors 82, 84. Collapsible guard rails 90 are positioned in front of front conveyor 86. Guard rail 90 is shown in three sections.

Side conveyor 82 is pivotally mounted on pivot rod 104 of bracket 102 to permit side conveyor 82 to pivot outwardly away from vehicle 10 so that side conveyor 82 is co-linear to front conveyor 86. A movable spacer rail 88 is positioned adjacent side conveyor 82 to assist in properly aligning each container as it is loaded onto the conveyor. Spacer rail 88 carries a plurality of spacers 94. When spacer rail 88 moves toward side conveyor 82, spacers 94 pass under outer guard rail 92 onto conveyor surface 82. Containers are placed between the spacers 94 to properly align the containers prior to their being conveyed to front conveyor 86.

An indexer 100 is mounted to the corner of vehicle 10 between side conveyor 82 and front conveyor 86. Referring to FIGS. 18-20, the indexer 100 includes a housing 106 and a wheel assembly 130, a motor 138, a gear box 140, and tensioner 136, a sensor 142 (for example, a BANNER sensor) and infrared sensors 144 and associated mounting bases 146. Mount 158 and fasteners 159 secure indexer 100 to the vehicle 10. Openings are provided in the mount for passage of the motor drive rod through to wheel assembly 130.

The wheel assembly 130 includes upper and lower plates 128 and 132, respectively, which rotate about a center axis 148 and are spaced from each other by posts 150. Each plate 128, 132 includes a plurality (eight are shown) of radiating spoke segments 152 defining container-receiving spaces 154 between adjacent spoke segments 152. In the embodiment shown, the receiving spaces 154 are concave in shape, having a relatively shorter first edge and an extended second edge. Containers are moved along side conveyor 82 toward indexer 100 and onto a slider plate 160 positioned beneath the open receiving space 154. Each container is moved into a waiting receiving space 154. The wheel assembly 130 rotates one position to move the container onto conveyor 86. The extended second edge of the receiving space aligns the container as it is moved from the receiving space 154 down the front conveyor 86. At the same time, a new container is moved from side conveyor 82 onto slider plate 160 and receiving space 154. In this manner, containers are passed in proper alignment from side conveyor 86 to front transfer conveyor 82.

In order to perform up-close positioning of the grabber-rail 60 and grabber-heads 62 so as to achieve ‘proper’ alignment with the containers for a full-row pick-up, despite the potential misalignment of the machine and grabber subsystem itself, or the misplacement of containers, an integrated sensing subsystem is preferably provided. The sensing subsystem 70 may utilize a stereo camera, a 2D Infrared laser scanner or other devises for capturing the coordinates of the objects to be transferred. See FIGS. 5-7. An example of a suitable laser scanner is the LMS 200 scanner manufactured by SICK, Inc. The LMS 200 laser scanner and those having similar sensitivity, reliably sense containers even in extreme conditions. Such worst-case conditions include, low sun, pots on snow-covered ground, and the line of sight of the laser being directly in the sun, with no shadows.

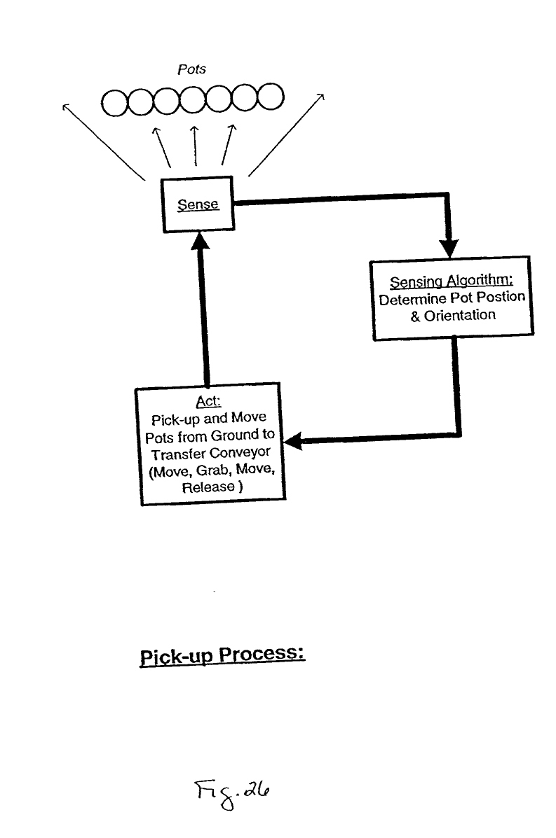

The sensory system used to control the machine heading, grabber-bar 60 and X, Y, Z and θ-positioning unit 38 and pincher open-close states of the grabber heads 62, is based on the processing of geometric range measurements from the planar laser-scanner system. The range measurements from the sensor device 70 taken in the field (see FIG. 21) are post-processed to obtain the line and orientation of the container-row on the ground (see FIG. 25), the machine heading (coarse motions) and the grabber-orientation (fine motion). The sensor interpretation algorithm performs a variety of calculations.

Referring to FIG. 25, first, the number of data points is reduced to include only relevant data as defined by the larger rectangle. Next, the raw data is analyzed to determine where it sees shapes that look like pots, after which the position of these pots is determined. A best fit line is then calculated for the group of pots (i.e. X, Y, Z and θ values). The position of each of these pots is checked to determine if they are within range and tolerance for successful pickup by the grabber head 62. Additional checks are made to determine if any obstacles are detected in the small irregular shaped polygon in FIG. 21. All of this information is used to control the coarse movements of the vehicle 10 and the fine movements of the grabber arm 60 and grabber heads 62. Additionally, the sensor 70 can be programmed to monitor taught areas and indicate (i.e. via discrete outputs) when obstacles are present in each of these areas. This feature is used for safety monitoring to ensure that the grabber subsystem 40 does not move from the conveyor to the ground or from the ground to the conveyor positions unless these areas are clear of obstacles and persons.

The sensor interpretation algorithm was written in C and runs on a special-purpose PLC module with two serial interface ports, utilizing a 386 processor. All data is transferred to this special purpose PLC module via an RS-232 serial interface. Those skilled in the art will recognize that any computer language and processors may be used to program and control the sensory interpretation and control features of the system.

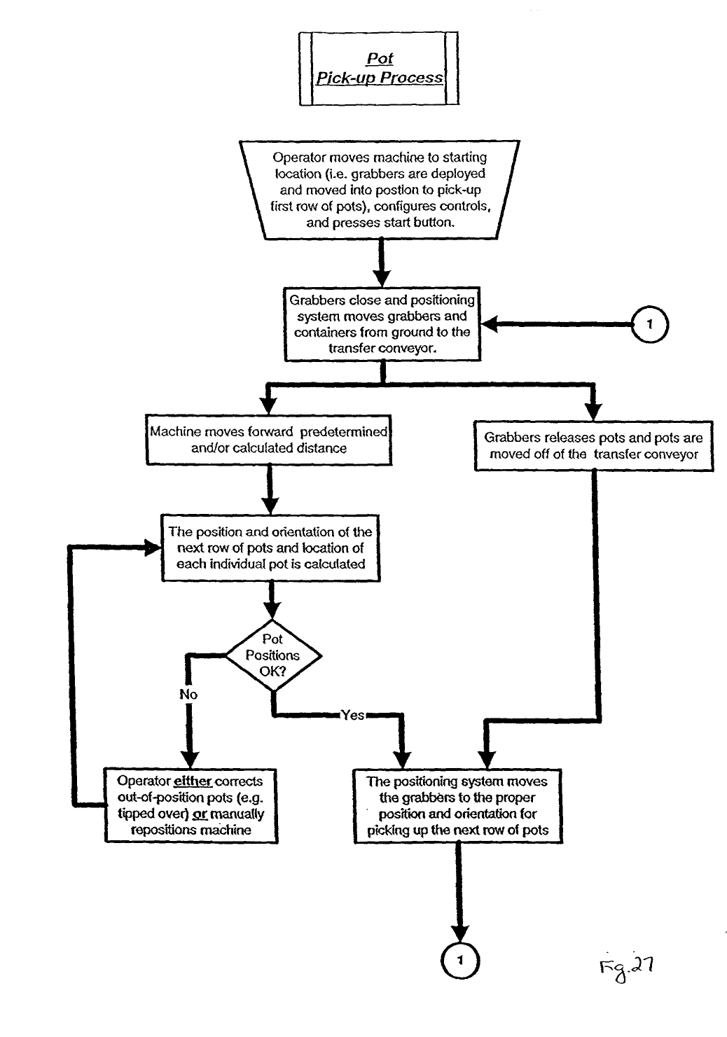

The electronics and control system may be based on commercially available, off-the-shelf industrial automation hardware. A high-level hardware architecture is shown in FIG. 22. The control system in the embodiment shown is based on Allen-Bradley SLC-500 line of programmable logic controllers (PLC). The PLC is housed in a ten-slot chassis with a CPU (SLC 5/05) and a variety of I/O cards including: discrete I/O (6 cards), analog I/O (2 cards), application development module (1 card −386 CPU). The discrete I/O modules are used for input from switches, push buttons, proximity sensors and IR switches and output to solenoid valves, relays, motor starters and indicator lights. The analog I/O is dedicated to the control of hydraulic cylinders that control the fine position and orientation of grabber heads 62.

The motion controller provides precise position or velocity control of the following axes: drive wheels 24 (2 axes), conveyors 82, 84, 86 (3 axes), grabber subsystem 40 (1 axis) and indexer 100 (1 axis). The system operator will interact and control the system via buttons, switches and a joystick on a remote control panel (not shown), or directly on the vehicle 10, using controls 36 mounted in (or on the surface of) compartment 32, as shown in FIGS. 2 and 7. The operator interface was designed and modeled after familiar industrial automation controls that may be operated without extensive training. A computer monitor and keyboard are not required to control and operate the system.

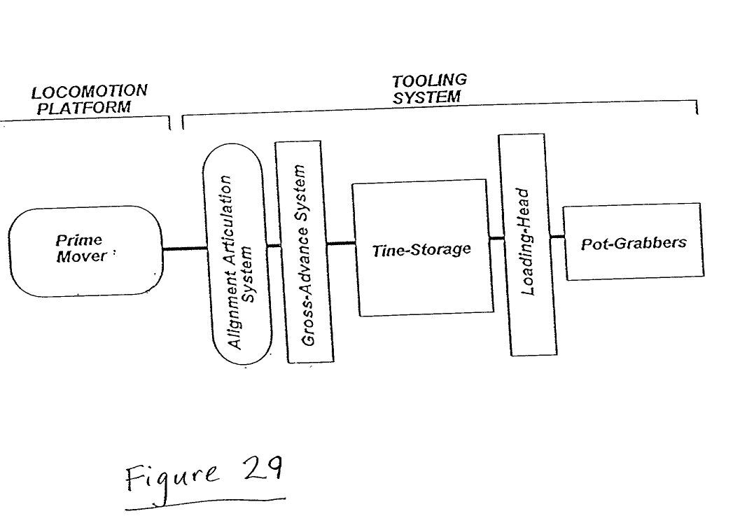

The control logic for the vehicle 10 was implemented using programmable logic controller (PLC) ladder logic and the associated hardware. The ladder logic was written in a modular systematic manner. This enables more efficient commissioning and maintenance of system software. The program consists of a main program, device control, input references, output references and several processes. The main program provides overall control. The device control is the only place where physical devices are controlled (.e.g. motors, valves, cylinders). The input and output references map all internal software variables to the real world I/O hardware. The processes are where the majority of all control logic and all control sequences are implemented. An embodiment of the software architecture is shown in FIG. 24.

A series of detailed flow charts represent the behavior and operation of the self-mobile system 10. The operation can be described in terms of a set of independent processes as follows: 1) conveyor load, 2) conveyor unload, 3) container placement, 4) container pick-up, 5) position system calculation, 6) position system, etc. Some of these processes are at the highest level and call other processes (e.g. container placement) and others are at the lowest level and perform a series of calculations or a series of basic tasks (e.g. calculate container positions, move conveyors in coordinated fashion).

Movement of the vehicle 10 via the drive wheels 24 is rather straightforward for both pick-up and placement of containers. In both of these cases, the grabber subsystem 40 makes all of the fine motions and the drive wheels provide coarse and basic moves. For container placement operations, the drive wheels make simple dead reckoned moves based on the type of container placing-scheme chosen by the operator (e.g. can-tight, can-to-can). In order to maintain a consistently straight set down path, the operator will occasionally have to pause the process and make minor vehicle heading corrections.

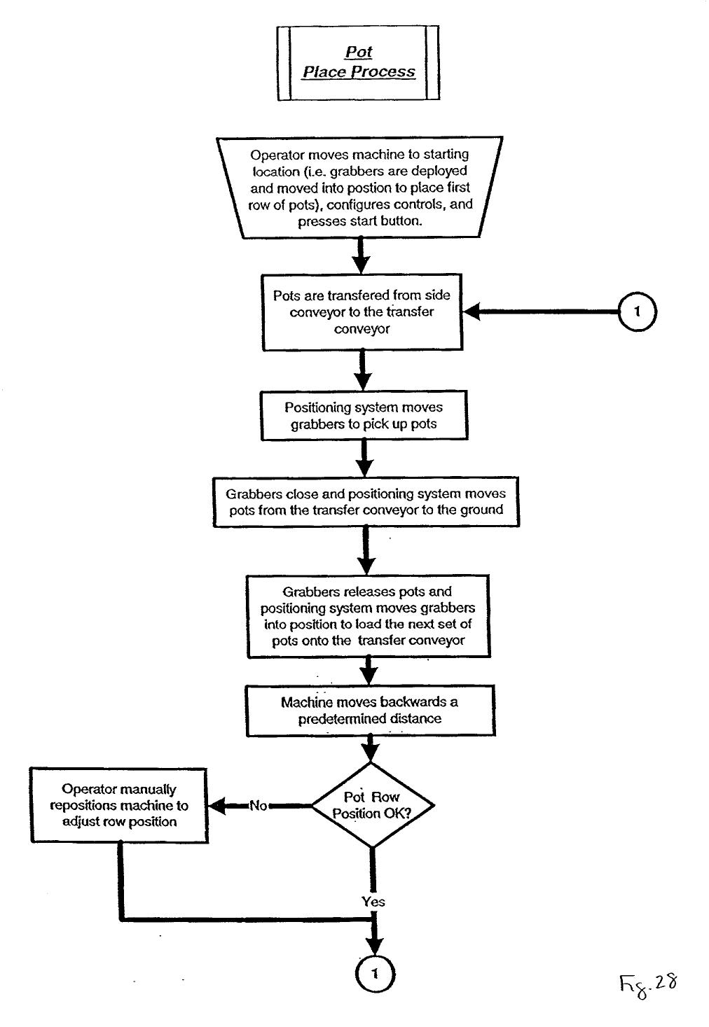

For container pick-up operations, the drive wheel motion uses the 2D laser data and operator selected can configuration to guide the system. The first move the drive wheels make is a dead reckoned move, while all subsequent moves are based on the 2D laser data. Heading and lateral corrections of the drive wheels are typically made only if the angular correction and lateral correction are above a predetermined threshold. This may be done in order to maximize system productivity and only these corrections when the grabber head may not be able to correct for the variations. This embodiment of the navigation approach is shown in FIG. 23.

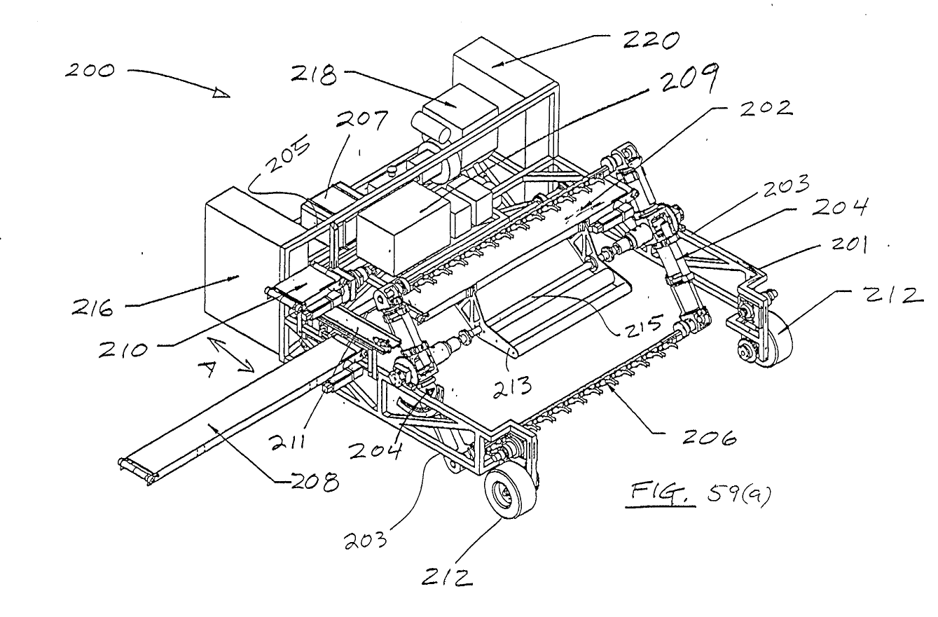

A field operation set up may include a trailer train 14 brought to the site by a tractor 12, as shown for example in FIG. 57, but with the vehicle 10 of the invention, placed in the field adjacent the trailers 14. The vehicle 10 is positioned for placement of containers from the ground onto the trailers 14 or placement of containers from the trailers 14 onto the ground using, in each case, the machine 10 to place groups of containers simultaneously. The side conveyor 82 can be positioned outwardly from the vehicle 10 or collapsed to the side of the vehicle 10, as necessary.

When the vehicle is used for placement of containers from trailers 14 to the ground, as shown schematically in FIG. 28, an operator moves the vehicle 10 to the desired starting location. The grabber subsystem is deployed into position behind the front conveyor 86 with grabber heads 62 in the open position. The spacer rail 88 may optionally be moved forward to move its associated spacers 94 forward onto the surface of conveyor 82. Two field operators are typically used to move containers from the trailers 14 onto the side conveyor 82, in between spacers 94.

When the conveyor belt is fully loaded, spacer rail 88 is withdrawn, the conveyor moved and the containers transferred to the front conveyor 86. If the conveyor 82 is extended outwardly from the side of the vehicle 10, as it may be commonly done in the field, the containers pass from side conveyor 82 to front transfer conveyor 86 in a straight line. If the conveyor 82 is collapsed to the side of vehicle 10, as may be commonly done when moving containers from a cold-frame house, the conveyor 82 moves the containers to the indexer 100, where they are assisted around the 90° bend to transfer conveyor 86 and moved into position in front of the grabber heads 62 of grabber rail 60. The grabber rail 60 is moved forward to position a grabber head 62 around each container on the conveyor 86. The hydraulically controlled grabber heads 62 are closed around the container within its grasp with sufficient pressure to secure the container in position, without damaging the container or the plant therein.

Front guard rails 90 are lowered, out of the path of the grabber rail and containers. (see FIG. 2, where one of the set of guard rails 90 is lowered). Then, the grabber rail 60 is raised by actuation of the cylinder 65 to raise frame 178 and vertical adjuster 58 to lift the containers above the conveyor 86. The grabber rail 60 is moved forward, then down and forward along an inclined path as the chain driven rollers 42 travel along the straight and sloped sections, respectively, of the carriage assembly 110.

Further fine adjustments of the position of the grabber rail 60 along the X, Y and Z axes and at an angle θ, may be made, using geometric positioning data received by sensor device 70 and calculated by the associates navigational software. For example, the grabber rail 60 may be moved further forward by simultaneous and relatively uniform actuation of each of the cylinders 52 to advance or retract extension adjusters 74 the distance necessary to position the containers in the desired location. If necessary, the grabber rail 60 may be pivoted about an angle 0 by the non-uniform, selective actuation of one or both cylinders 52 and the associated relative movement of extension adjusters 74. That relative, non-uniform movement causes uneven movement of extension mounts 48, which causes frame 78 to pivot about pivot rod 72, to achieve the desired orientation. By actuation of hydraulic cylinders connected to the horizontal adjusters 56(a), the grabber rail 60 may be moved to the right or left as calculated by the imaging data and navigational software to position the containers in a desired position.

Can to can or can-tight configurations on the ground can be accomplished by jogging of the grabbing head as desired by the operator. Placing the containers in a spaced configuration is accomplished by jogging the grabber rails laterally, as well as moving the vehicle if needed. When the adjustments needed to position the containers have been made, the grabber rail 60 is lowered by further actuation of cylinders 65 and frame 178 to place the containers on the ground. The individual grabber heads 62 open to release their respective containers.

In addition, the grabber heads 62 preferably have hydraulic circuits, which allow every other head 62 to open or close, so that containers may be deposited in an even/odd manner. After release of the odd containers, for example, the grabber rail 60 would be retracted and the remaining, even containers, may be released by opening the even grabber heads. The grabber rail is moved back, away from the containers.

The grabber rail 60 may then be returned to its original position behind the conveyor 86 by the reverse of the path just described to grasp the next set of containers. The vehicle 10 may be moved backwards by the operator to create room for placement of the next row of containers on the ground. If the allotted position for the next row of containers is suitable, the operator repeats the process as described above. If the position is not suitable, the operator repositions the vehicle 10 or adjusts the controls for positioning with the geometric positioning unit 38.

If the vehicle 10 is to be used to pick up containers on the ground, as shown schematically in FIGS. 26 and 27, the operator moves the vehicle 10 to the desired starting position. The geometric location of the containers is scanned using sensor device 70. Then the grabber subsystem is deployed to move the grabber rail 60 into position in front of the first row of containers. Further fine adjustments, as described above, are made to precisely position the grabber heads 62 around each container in the row. The grabber heads close around the containers and the geometric positioning unit 38 moves the grabber rail 60 and containers from the ground to the front transfer conveyor 86. The grabber rail 60 lowers the containers onto the conveyor 86, the grabber heads open to release the containers, and the grabber rail is retracted, away from the containers and conveyor 86. Conveyor 86 moves the containers laterally to side conveyor 82, where operators move them onto a waiting trailer 14.

The vehicle 10 may be moved forward a predetermined and calculated distance, if needed, or the grabber rail may be lowered to the ground, as described above, and moved forward to the second row of containers using the extension adjustors 74. The best method of advancing the grabber rail 60 would be determined in each case by the operator. The position and orientation of the next row of containers and the location of individual containers is calculated. If the container positions are suitable for pick up, the grabber rail 60 is moved forward to the correct position and the grabber heads grasp and lift the containers. If the position of the containers is not correct, as determined either by the sensor data or the operator, the operator may, as appropriate, move any out of position containers or re-position the vehicle 10. Also, further actuation of the four assemblies of the geometric positioning unit 38 may be employed as described above to correct the grabber rail position. When in the correct position, the grabber rail moves forward, the grabber heads close around their respective containers, grasping them with sufficient pressure to secure them for the transfer, and the grabber rail is moved back and up to and just behind the conveyor 86. The containers are released and the steps repeated until all of the containers are picked up and transferred to a waiting trailer 14.

The container handling system presented herein represents a major step towards automation of labor-intensive container-handling tasks in medium to large sized container nurseries. The system represents a new class of smart outdoor automation systems utilizing existing hard-automation components, aided by smart sensors, intelligent software and innovative mechanism design. Testing of the system has shown its capability to achieve the productivity of 25,000 to 45,000 containers per day with up to two operators, without regard to the type of hauling-trailer. Experimental trials have shown the system to reliably handle 29,000 containers per 8-hour day with less than a 3% failure-rate. The system is capable of handling a large variety of commercially available containers. The self-mobile vehicle was shown in tests to work well on varied ground surfaces, such as gravel or woven groundcover.

Prime Mover Accessory Embodiment of the Handling System

The locomotion platform to which the accessory is attached can be one of a variety of different prime-movers already in wide use across the nursery industry, such as, without limitation, a tractor, articulated loader, or the like. An example is shown in FIG. 66. The handling system itself is comprised of various subsystems, or modules: (i) the alignment articulation subsystem, (ii) the gross-advance subsystem, (iii) the tine-storage subsystem, (iv) the loading-head subsystem and (v) the grabber. All these subsystems are depicted in FIG. 29 in a block-diagram format identifying their relative location and interaction with the rest of the system:

The roles and interconnections of each of the above subsystems can be generically described as follows:

The prime mover is responsible for getting the tool into the field and performing the gross motions between the trailer and the growing field or cold-frame, as well as the rough alignment of the tool to the growing-bed. It is intended to be a commercially-available field-system such as a tractor, loader, etc.

The alignment articulation subsystem is required to provide for the fine alignment of the container-loading system to the bed—this is important as it is unlikely that the driver of the prime-mover is able to accurately position the tooling system to perfectly load it (plus many prime-movers are not overly maneuverable). The alignment will consist of lateral back-and-forth motions as well as a rotational joint (actuated in reverse order). The alignment may be performed manually or aided/automatically utilizing front-mounted container-scanning sensors, similar to the scanner described above.

The gross advance subsystems' purpose, once the handling system is properly aligned to the growing-bed, is to advance the tine-storage and grabber-head into the rows of pots on the ground at a rate so as to allow the containers to be picked up one row at a time. This gross advance subsystem can take the shape of an articulated boom, backhoe-arm, scissor-linkage, etc. This subsystem thus serves as the high-accuracy positioning system in light of not having a computer-controlled prime-mover.

The tine-storage subsystem will hold the rows of pots that are fed to it by the grabber-head. The tine storage subsystem may be sized to hold a certain number of pots of a certain size and is able to index them forward or backwards, depending on whether the subsystem is loading or unloading pots. The tine-storage can be mechanically or electronically (i.e. via sensor feedback and computer-/logic-control) linked to the grabber-head so as to allow the hand-off between these two subsystems. The indexing tine-storage permits maximum parallelizing of the pickup actions so as to minimize cycle-time. The tine-storage subsystem is also mounted on a vertical lift system akin to those on forklifts, allowing the entire tines (once full or empty) to be raised/lowered to the proper height for trailer-unloading or setting down pots in the field. In combination with the gross-advance subsystem, it allows for the drop-off of a fully loaded tine-subsystem without requiring the row-by-row unloading method (reverse of loading method).

The loading head holds the grabbers and provides for sideways, backwards and up/down articulation to align the grabbers to the next row of pots to be grabbed, a lift of the same once the grabbers are closed, a shuttle over to align the containers in the grabbers with the spaces between the tines, backwards and downwards to transition the containers from the grabber-head to the tine-storage subsystem. This process is repeated over and over and allows for the pick-up and drop-off of can-tight and staggered rows of containers. The grabber-head also has built-in sensors that detect the distance to the row of pots and their inter-pot spacing, allowing the system to align itself properly for the next grab or drop-off. Sensors may be ultrasonic, infrared, such as an infrared distance-measurement sensor, machine-vision, or other suitable position sensors. The grabber-head is thus an electro-mechanical subsystem (optionally with the on-board controller/computer system built-in) whose articulation, travel and sequencing may be programmed and/or operated and supervised by the operator.

The grabbers are the electromechanical subsystem responsible for positively engaging and locking in the container during the phase of transitioning the container from the field onto the tine-storage subsystem. The grabbers may be configured to be applicable to the large variety of container materials, sizes, lips, and configurations that are currently in use in the industry. Several approaches are possible, some of which will be described further herein.

The locomotion platforms that may be used include outdoor rough-terrain prime-movers, such as those in use in the construction and farming industries. The options range from small-scale front-/skid-loaders, to rough-terrain forklifts to articulated or ackerman steered loaders and/or tractors.

In any of the aforementioned prime-movers, the size, weight and power-requirements of the handling system of the present invention would be considered in determining which prime-mover is best suited for the trailer under the circumstances present in the field. It is however clear that the selected system should be able to perform many duties in a nursery throughout the year, rather than just be dedicated to container-handling, as that represents maximization of utility of any piece of equipment.

As shown in FIG. 29, the handling system of the present invention consists of several subsystems, which are detailed in terms of their potential options below.

The alignment articulation subsystem, which aligns the tines to the proper height, orientation and lateral location of the containers on the growing-bed, may be implemented using a variety of already-existing actuation devices (cylinders, linkages, etc.) available as OEM add-ons.

The gross-advance subsystem is utilized to advance the storage-tines into the growing bed along the proper orientation so as to continually load containers onto the trailer (or off the trailer upon set-down on the trailer or the field). Options that may be employed include, but are not limited to, systems that function like backhoes, articulated booms, scissor-mechanisms, and the like.

The tine-storage and conveyance subsystem is a combination of an active indexing mechanism and a passive container storage system. The tines may be considered to be a storage device capable of feeding a complete row of containers away-from or to the grabber-head, allowing the machine to operate in continuous fashion when picking-up and dropping-off containers. The tines themselves may be in the form of a set of long forks mounted at the base to the gross-advance subsystem, with their front interfacing with the container loading-head. Along the top and bottom of the tines runs a continuous conveyor-chain with add-on features that allow pots placed between tines to be retained along their diameter and no higher than the lip of the container.

These tines have the proper length and spacing to hold the appropriate number of pots (dependent on container-size) to transfer to and from the trailer and onto and from the growing-bed. The tines may be laterally (manually or powered) settable so as to allow a single handling system to adapt to several container sizes. In one embodiment, the full width of the tine-area may be, for example, around 6 to 7 feet (about the width of a growing-bed to allow for manual order-picking through bend-over) and about 4 to 6 feet long (width of a typical nursery-trailer to width of a typical wooden pallet which some nurseries place atop trailers being loaded to ease unloading on the other end).

The dimensions of the tine-spacing and the nature of the retention device running along the conveyor-chain must be selected so as to have proper vertical support and longitudinal indexing of any container-planted material in the field. The hand-off between the grabber-head and the tines may be a simple and open-loop position-based gravity-aided placement of the containers into the tine-storage system at the front of the same.

The passive gravity-fed rollers and low-friction material would imply a set of small cylindrical rollers mounted atop the tines, allowing rows of pots to be placed and gravity-fed or pushed along the tines to the base of the tines-loading this concept is simple, yet unloading in a row-by-row fashion might be tough—especially if the pots are overly flexible and dirt begins clogging the rollers. The chain-driven brush-fingered container-nests would utilize slightly-inclined nylon brushes mounted to a conveyor chain to support the pot-lip by virtue of spreading the load on the buckling brushes of a certain diameter and length, allowing pots to be conveyed and indexed at will—issues here are the roundness and integrity of the pot and lip and the center-of gravity location to avoid container tip-over once on the tines (e.g. once it is no longer held by the grabbers). The rubber-membrane system is akin to the brushed fingers, except that it could support a pot better along its circumference and again ease conveyance and indexing for (un) loading—concerns are similar to those stated above, including wear and overall container-stability during indexing and transportation and drop-off.

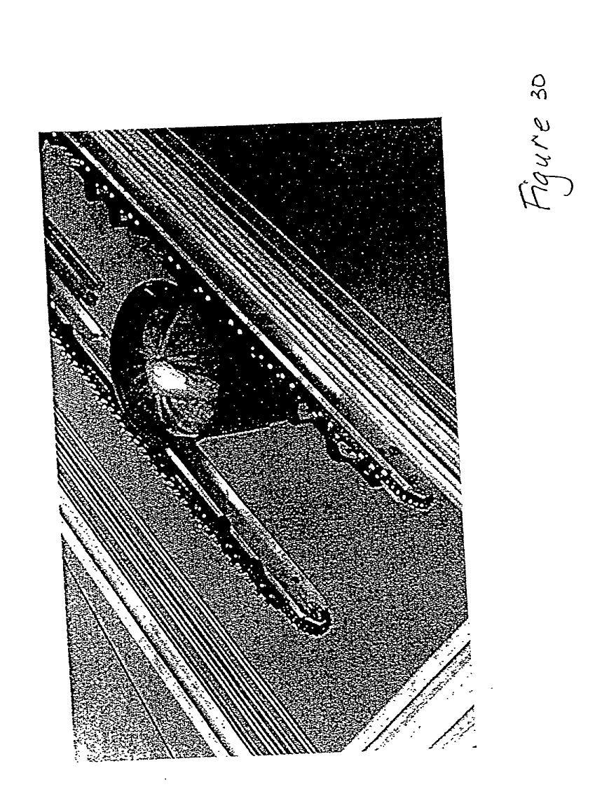

Two double tine-systems with an integral conveyor chain-drive were assembled. A variety of different retaining features (brushes, rubber-lips/edges, etc.) may be attached to the tine-system. One system having a taller tine cross-section was used to test the principle, and a shortened-height version was built to allow interfacing with the grabber-head and grabber-subsystems, travel along the tines, and storage for drop-off and pick-up. The two dual-tine systems are shown in FIG. 30.

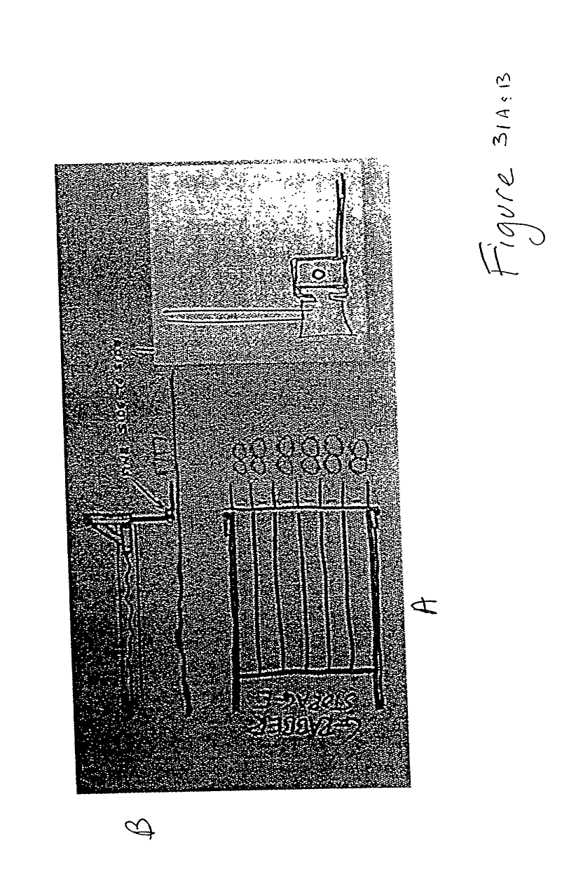

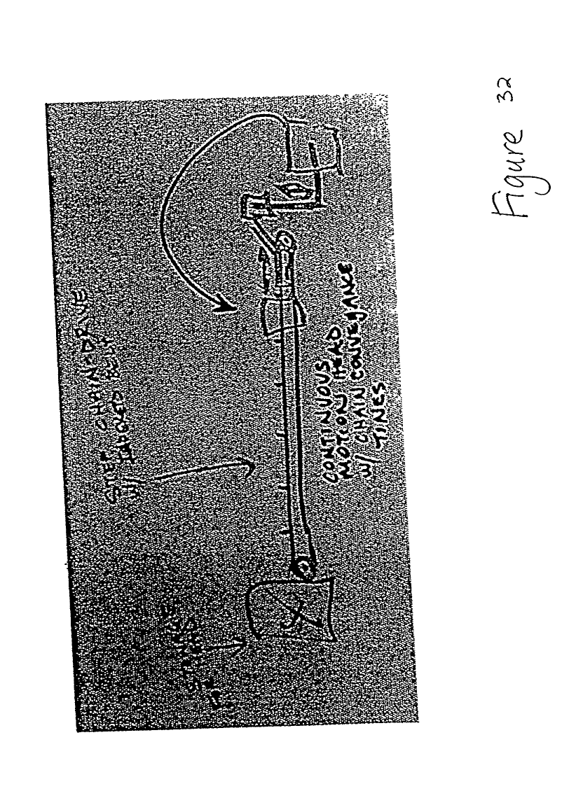

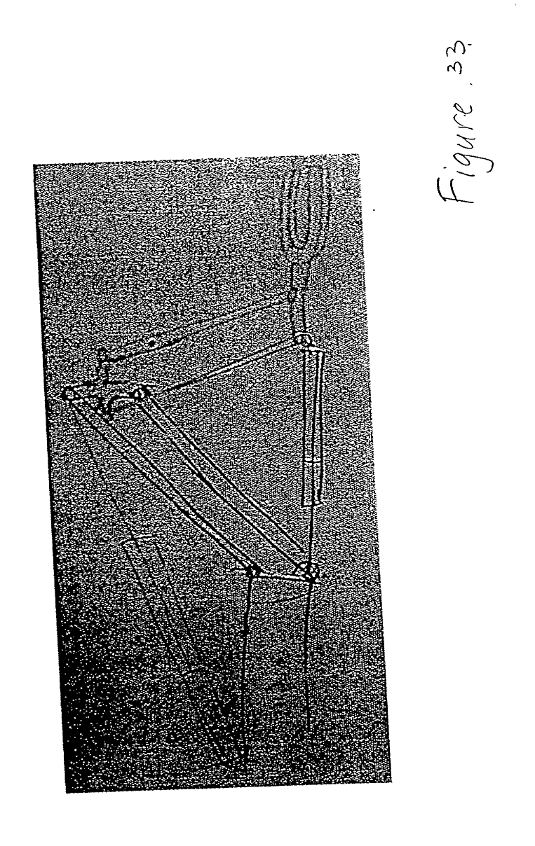

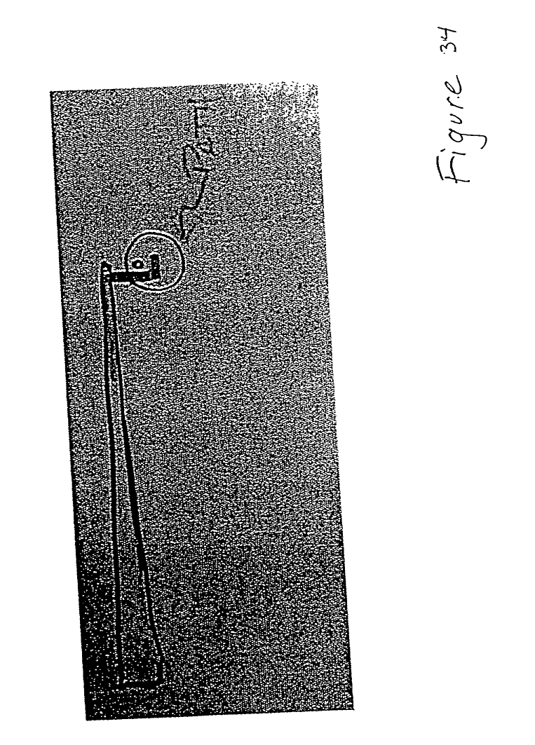

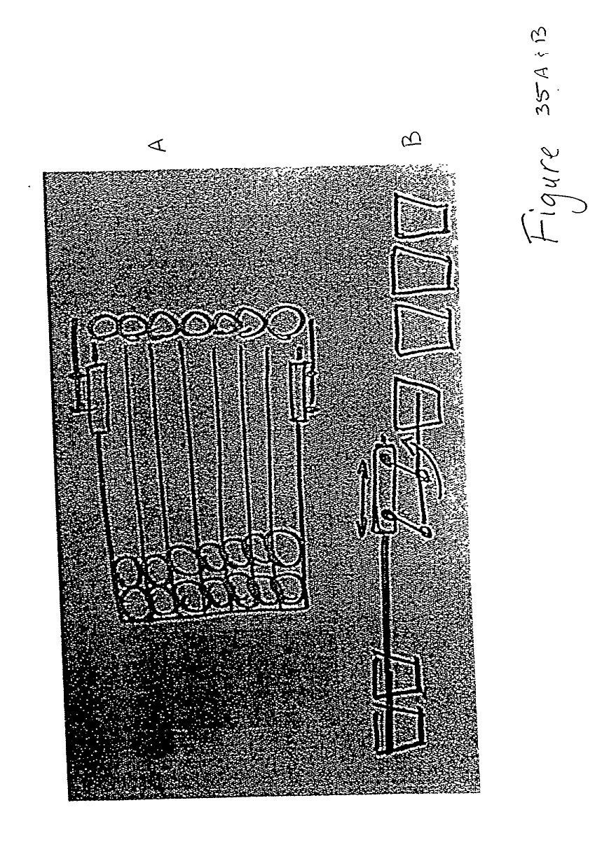

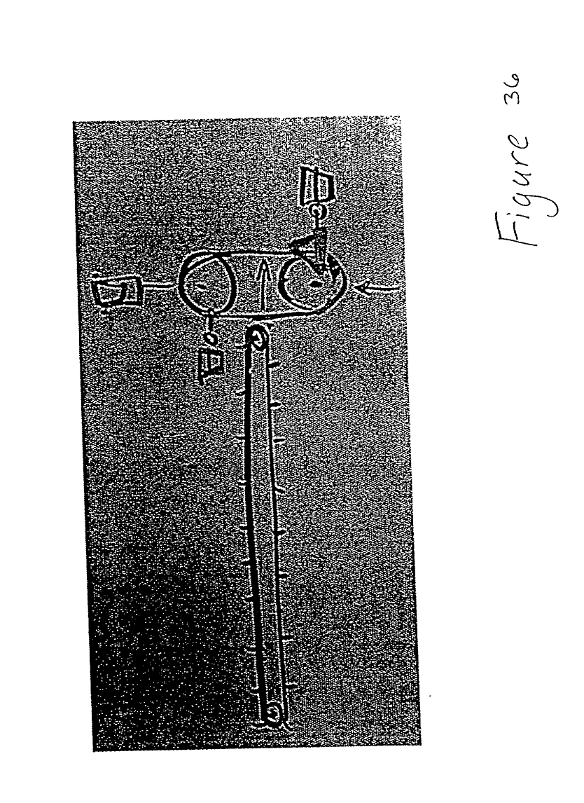

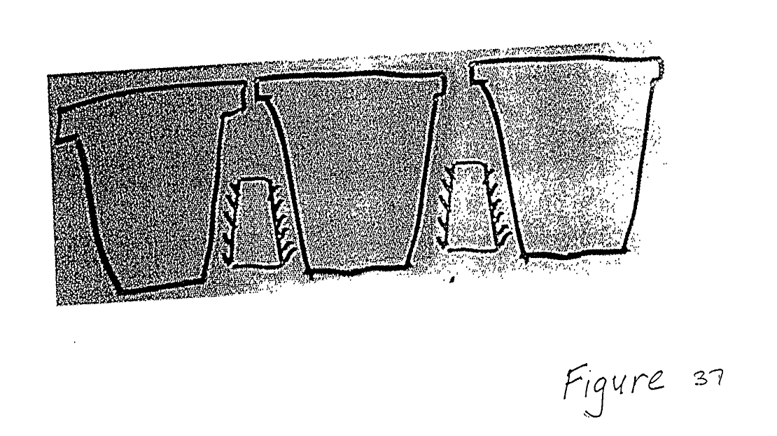

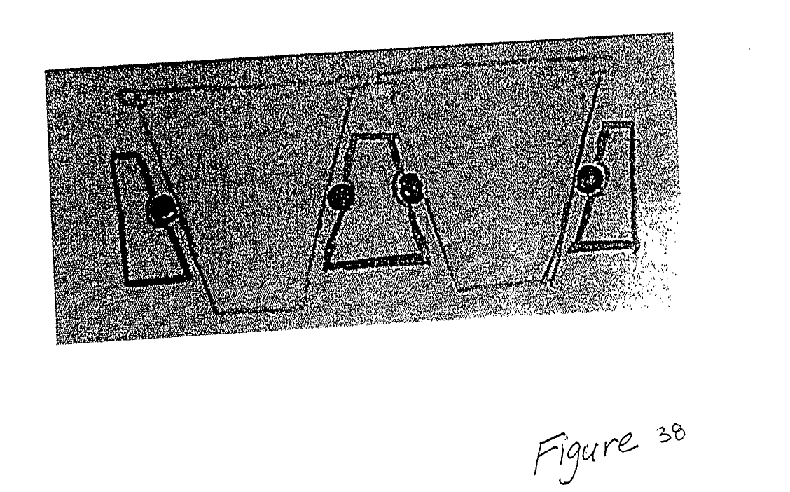

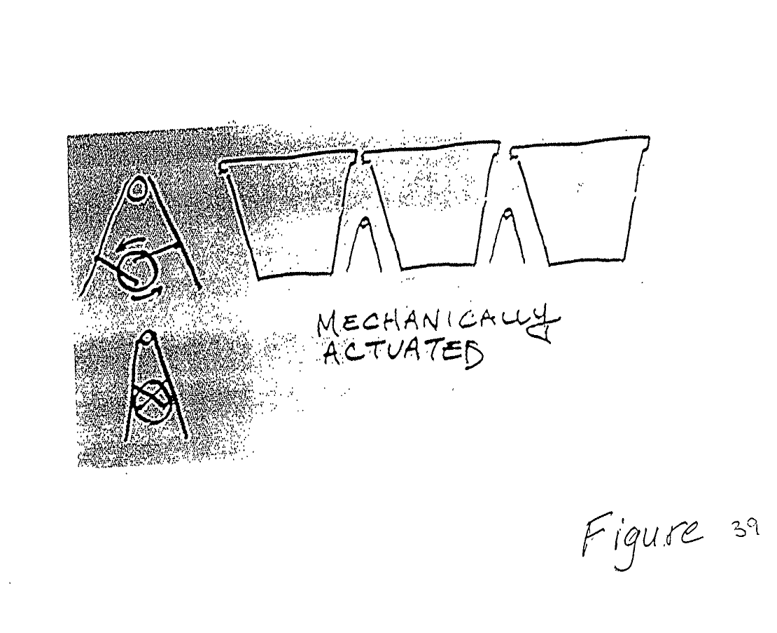

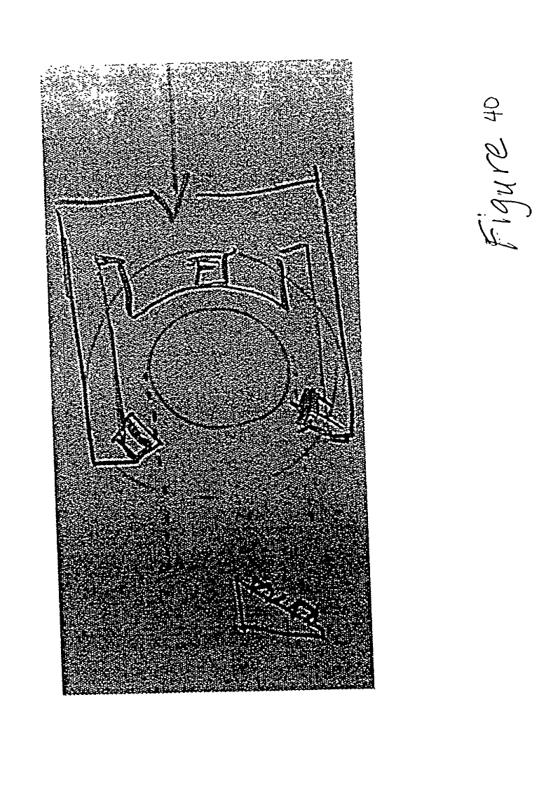

The container loading-head or grabber-head is the most intelligent and multi-purpose component of the handling system of the present invention. It holds the individual container-grabbers and sensors responsible for proper alignment and grabbing/holding and handling of the container from/to the growing-bed onto/off-of the tine-storage system. An embodiment of the tines and grabber-head interact is shown in FIGS. 31A & B and 32.

In addition to the combined tine/head concepts shown in FIGS. 31A & B and 32, a few additional ones were developed by the project team—they are shown in FIGS.—33-36.

The goal of the loading, grabber-head is to transfer the containers once grabbed, from the ground onto the tine storage system. Since cycle-time and stable transfer are key drivers in this system, coupled with the requirement for simplicity and ruggedness, the afore-shown concepts are fairly simple in nature. One concept might be to utilize parallelogram linkages to extend and then lift the container onto the tines. Another might be to have a simple fixed can-following path that the grabber-head follows, thereby combining forward/upward/backward and downward motion into a single mechanism to perform all the required motions with a single actuator. A combination of the two can be seen in the 4-bar cam-linkage to continually lift and deposit row-after-row of containers on the indexing tines. Yet another concept would involve a more vertically-oriented Ferris-wheel chain system that utilizes grabbers in a gimble to grab, lift and lower the container onto the tines without tipping the container. Most of these concepts have several pros and cons that tend to make them unlikely candidates for a final implementation. Other concepts were also explored further experimentally and are detailed in a later section.

The experimental testing was primarily carried out using a lift pallet-jack, thereby simulating the combined articulation of the loading-head and tine-storage system. Since this was not overly realistic and time was of the essence, we decided to only prototype an experimental version using the final and improved grabber-system operating in conjunction with the final tine-storage system. The loading-head that was prototyped was thus designed to hold the final and improved articulated butterfly pinch-grabber, and be manually/actively articulated so as to showcase the degrees of motion being envisioned in the final system. The material of choice was aluminum extrusions that allow for a multitude of arrangements and should thus not be construed as the final design nor the material of choice for the field-version.

The loading head that was built for the dual-tine test-system consists of a rectangular frame-structure built from 80/20 differently-sized aluminum extrusions, which hold the container-grabbers and their articulation in a single setup, while also allowing for travel along the outside of the tines for lifting, backing up and dropping off of the containers onto the indexing storage-tines.

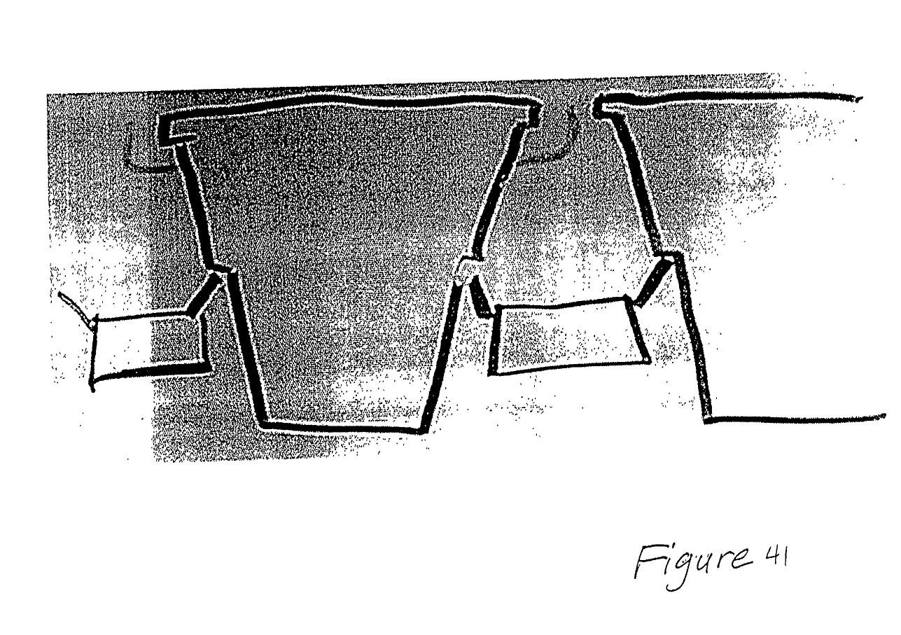

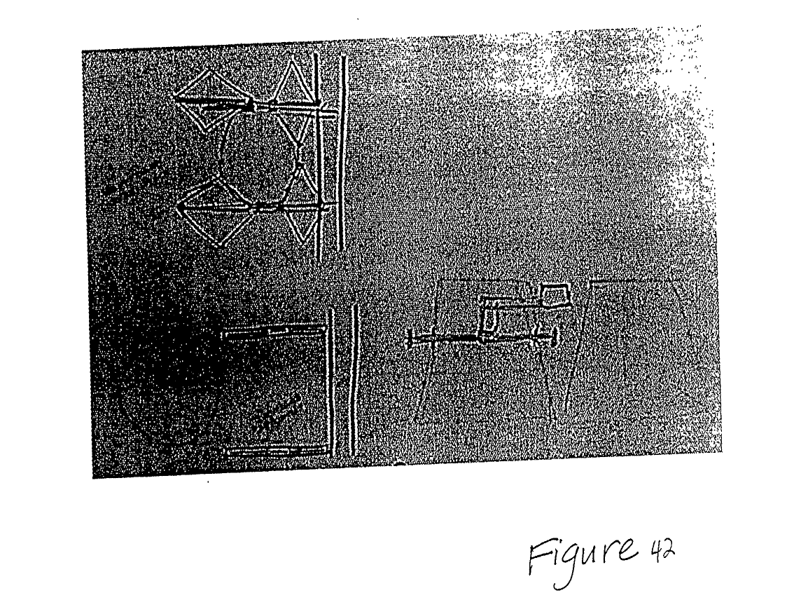

The container grabber is the actual system used to make contact with the container and retain it in a firm ‘grip’ during the lifting and traversal phase from the ground to the storage tines (and in reverse during set-down). Many ideas, including passive and active tines were considered and experimented with. The main ideas are shown in FIGS. 37-45. The proposed concepts are either passive, taking advantage of the natural draft-angle of the container (needed for manufacturing), or other more active and clamping-devices that exert an active retention force against the container. The concepts range from rubber-fingers, to stiff brushes to inflatable sidewall-bellows to even can-actuated lifting-tines—the possibility of a novel container-design was also explored, easing the grabbing and tine-storage by providing double-lips at the mid-height point of a container as well as at the rim of the same.

The grabber systems that were built comprised a vast array of those conceptually presented in an earlier section. Each of these will be discussed individually in this section, including the pros and cons that were determined as part of the experimental evaluation of the same:

Rubberized fixed-angle Tines

The rubberized fixed-angle tines take advantage of a somewhat fixed container-spacing in the field as well as a draft-angle of the container. Once the fixedly-spaced tines are placed between containers, the tines are lifted and the inclined and rubber-finger covered tine surface engages the sides of the pot and lifts it until the container stops slipping through the tine as the dirt-filled container can no longer deform—the container is now firmly held and can be transported away from the bed (onto the tines). A picture of the pre-prototyped grabber (in wood and rubber) is shown in FIG. 46.

The positive aspects of this design are its simplicity and thus cost-effectiveness and ruggedness. On the other hand though, we found that the type of material of the container, the degree to which it is filled or how compacted its soil is, as well as the type of lip on the container, has a large impact on the ability to repeatedly and stably pick up the container. It is believed that by shrinking the tine spacing many of these problems can be overcome, but we believe that this might have operational drawbacks in terms of requiring almost ‘perfectly’ spaced containers in the field, which will certainly be tough to guarantee. In addition, it is unknown what the height of each of these containers will be once grabbed (due to their non-deterministic slippage behavior), which can represent a problem during the hand-off to the indexing tine-storage system. For this reason we have continued evaluating further grabber candidates.

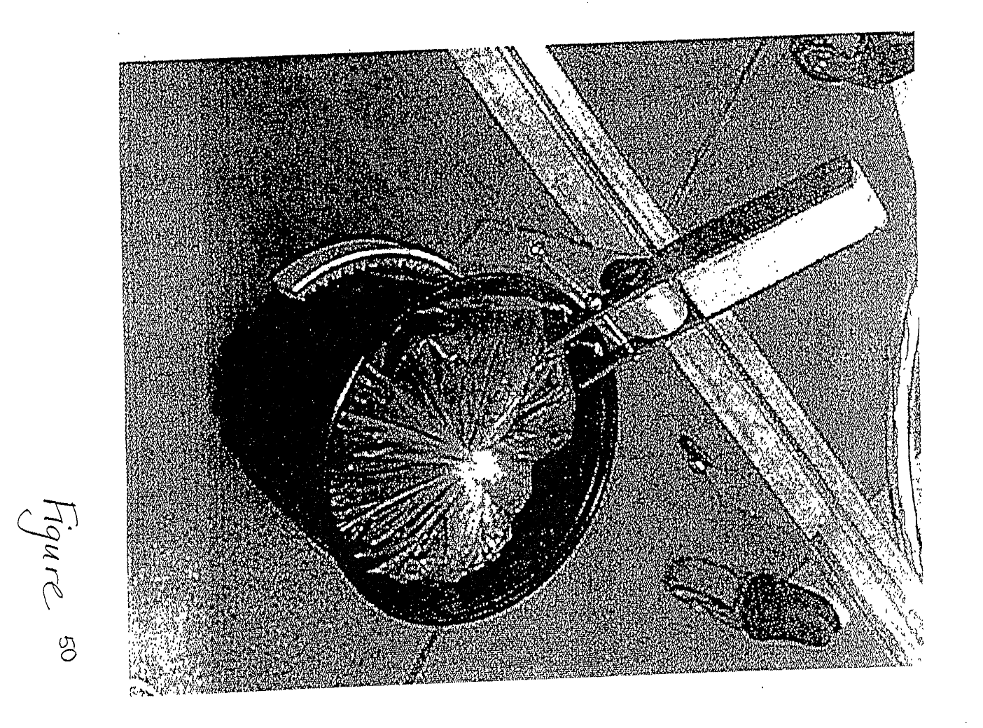

In order to reduce the amount of container-deflection due to a single two-point or dual line contact as was the case in the rubberized-tine experiment, we developed a set of fixed-diameter half-circle PVC plastic-grabbers mounted on a fixed tine-spacing in order to pick up a certain size container. The principle is similar to the previous one, in that the container will wedge itself and stop slipping through the hoop as it is picked up, due to the draft on the container and the soil, which provides the internal compressive rigidity of the container. The described system was built again from wood and PVC, with a result as shown in FIG. 47.

Lean-back half-moon support-rings on fixed tines

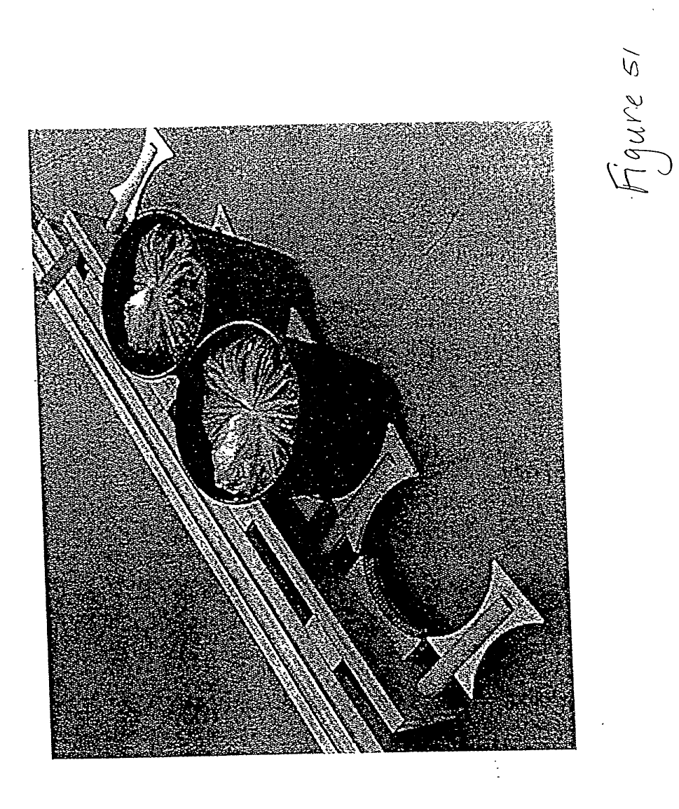

In order to alleviate the tendency of containers to tip out of the semi-circular support-ring, the same PVC-rings were mounted at an inclined angle and then slightly oversized (about 200 degrees of circumference). The goal was to try to recline the container and grabbing it better, so as to keep it from falling off the grabbers. The built prototype is shown in FIG. 48.

Circular flexible lip-supports on passively-rotating tines

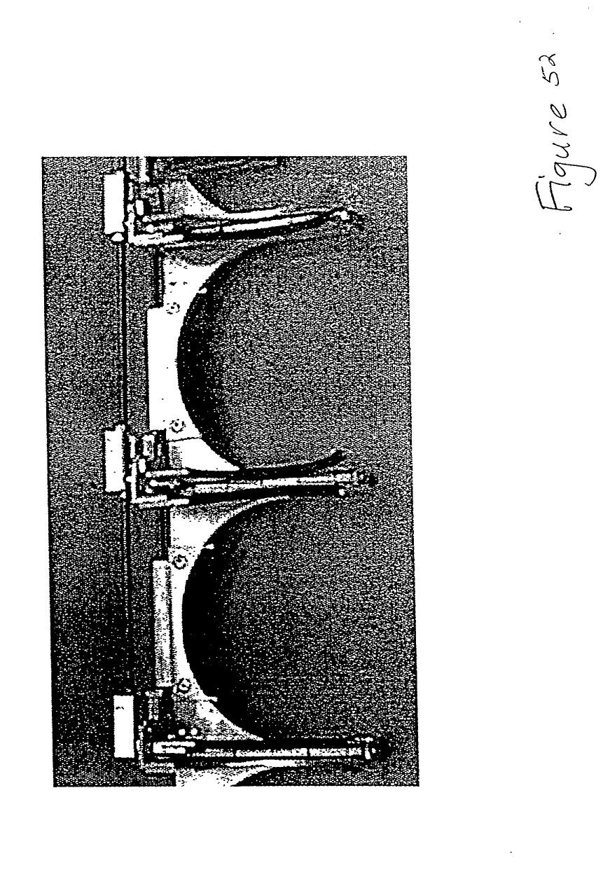

In an attempt to develop a circular-support lifting system which was more flexible with respect to container misplacement in the field, a simple grabber, again with semi-circular support rings, was developed where the mini-tines supporting the ends of each of the semi-circles were mounted on freely-pivoting hinge-points, allowing the containers to ‘squeeze’ themselves into the proper location even without being perfectly placed, without the fixed tine crushing the container during the advance of the gross actuation system. A picture of the prototype developed in wood and PVC is shown in FIG. 49.

Pinch-grabbing container-lip and support retainer

Having a positive and known grab at a fixed and known location of the container may be desirable, and possibly the best situation for handling and drop-off, it was decided to prototype simple mechanical pinching system that supports the container on the side, and pinches the lip and thus locks the container into an unmovable position—this is basically a replication of what humans do with the containers when they pick them up in the field! A picture of the grabber itself and holding a container, is shown in FIG. 50.

Rotating butterfly pinch-grabber on fixed tines

Since a better low-down grab of the container was desired, a pinch-grabber as developed that would physically interfere and slightly deform a container near the base along almost a full-circular arc, thereby drastically reducing the tendency of slippage and taking container-type and—integrity as well as soil-conditions out of the list of variables impacting a successful grab. The first version that was prototyped, used an hour-glass shaped set of grabbers that were turned along their axis using a simple lever mechanism—a picture of the prototype (in wood) is shown in FIG. 51.

Improved articulated butterfly pinch-grabber

The improved grabber that was built based on the experimental results gathered with its wooden cousin, is shown in FIG. 52.

In order to perform up-close positioning of the grabber-head so as to achieve ‘proper’ alignment with the containers for a full-row pick-up, despite the potential misalignment of the tool system itself, the misplacement of containers, etc., requires the use of an integrated sensing system. The possibilities we explored ranged from the simple to the exotic, including mechanical feelers to lasers and cameras. The most suitable candidate for simplicity, ruggedness and reliability turned out to be a non-contact infrared ranging system. The principle is to use infrared light emitted and reflected from an object in the beam's path, whilst timing the travel-time of the returned signal, to determine the distance of said object from the base of the sensor. Based on this principle we should be able to integrate one or more of these relatively short-range (4 inches to 2 feet depending on IR diode-power) sensors into the grabber-head, so as to not only achieve a good ‘average’ sensory-alignment reading, but to also have a much better idea of the alignment of the row in the field, which will be useful if we are to properly space containers in the field.

The test-setup developed includes a suite of several IR sensors, which are multiplexed through a computers I/O port (parallel in the experimental setup's case) to obtain range-readings from each sensor at a rate of 10 per second. These readings are then processed based on the calibration-curve for each sensor, and then a range-map is built. If the sensor-array is moved laterally and in front of a row of pots, an image can be generated which a computer can interpret so as to determine the inter-container spacing, which in turn can be used to determine the proper location of the gaps between the containers, which are the locations that the tines of the grabber-head need to reach into. This process is what makes the accurate tine-placement possible so as to provide final alignment for the grabber-head prior to picking up several rows of containers. This data can then also be used (if desirable) to reactivate the alignment actuators to properly fine-tune the alignment of the storage-tines to the actual bed-orientation (as set by the placement of containers).

The block-diagram of the software that would be developed in order to perform the ranging, computation and grabber-head alignment (and possibly even the gross alignment), can be depicted as shown in FIG. 25.

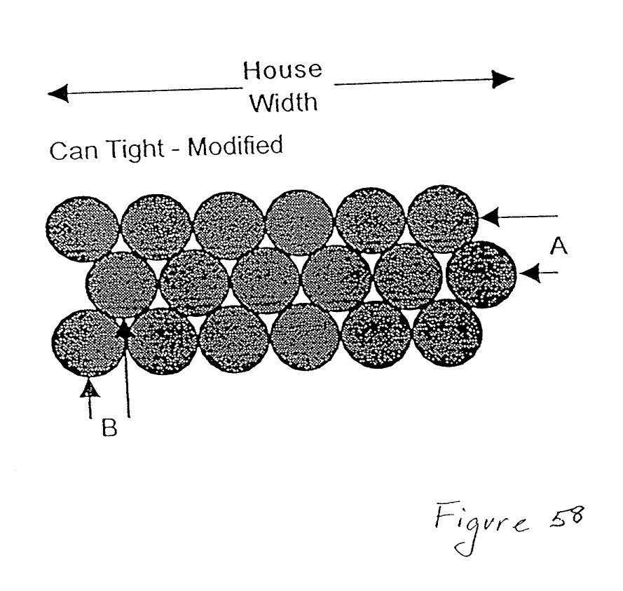

The proposed system concept for the handling system of the present invention is shown in operational settings of outdoor field-nurseries on growing-beds and inside/outside of growing-/cold-frame houses (see FIG. 56). Notice that we are showing a single operator sitting in a typical ackerman-steered tractor, with the tool front-mounted for operations in the field (i.e. right on the growing-bed). A second operator is responsible for moving the trailer-train to- and from the growing-bed—the same operator could also make sure that the containers on the bed are appropriately placed (i.e. not tipped over or severely misplaced), so as to ensure that the—handling system can work at its maximum efficiency.

Even though the system is shown as front-mounted in this rendering, the same tool could be rear-mounted, possibly facing sideways, to allow the tractor to set down or pick up a row from the side. Should the system be used in a cold-frame for moving into the field at the beginning of the growing-season, or consolidation for the winter, the same system could be utilized, as shown in FIG. 56. The reason for the differentiation lies in the fact that some nurserymen will remove the poly/plastic from their cold-frames completely, allowing them to use said bed-space as growing-space for the season, while others simply partially roll up the sides of the plastic all along the length of the house and also utilize said space.

In the full plastic removal case, the tractor can drive in from the end of the house and pick up or even drop off (in the case of pre-winter consolidation) containers, as the exhaust fumes can freely escape without harming the plants. The trailers will need to be parked at the end of the house and somewhat offset to allow the tractor to maneuver in/out of the house. In the case of the side-wall roll-up of the plastic, the tractor can drive alongside the cold-frame and the tool be mounted on the rear (or the front) and pointing laterally so as to allow the reach-in pickup (with the 2×4 wooden tack-down base-board removed to ease access) from either side and subsequent drop-off (or unload) from a trailer-train parked alongside the tractor. In both cases it would be advantageous if the hoops could be either temporarily removed or flipped up so as to avoid unreachable containers for the tool, which would have to subsequently (in parallel or even prior to the use of system of the present invention) be picked up manually.

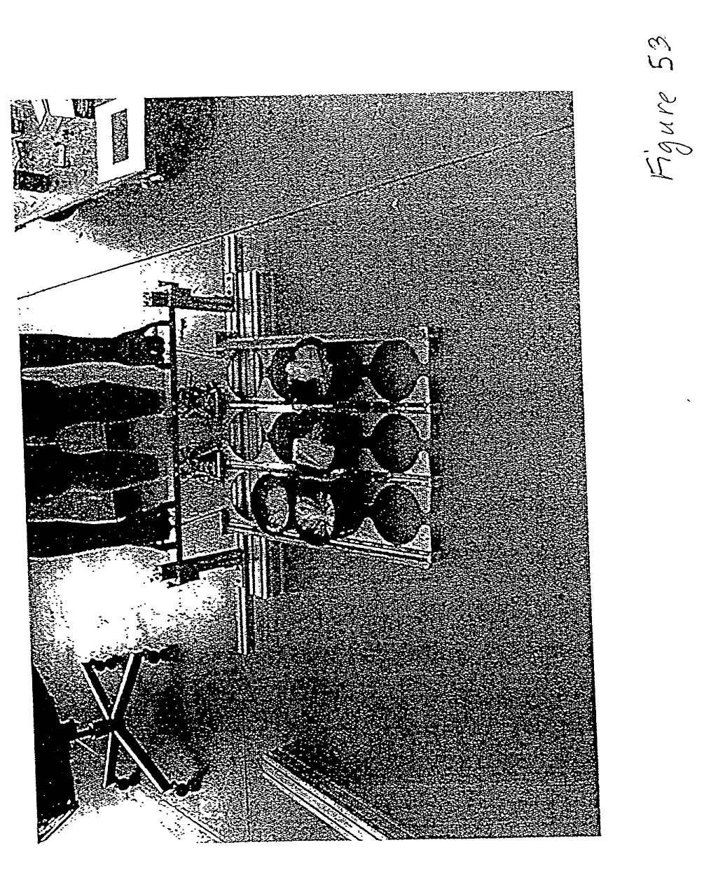

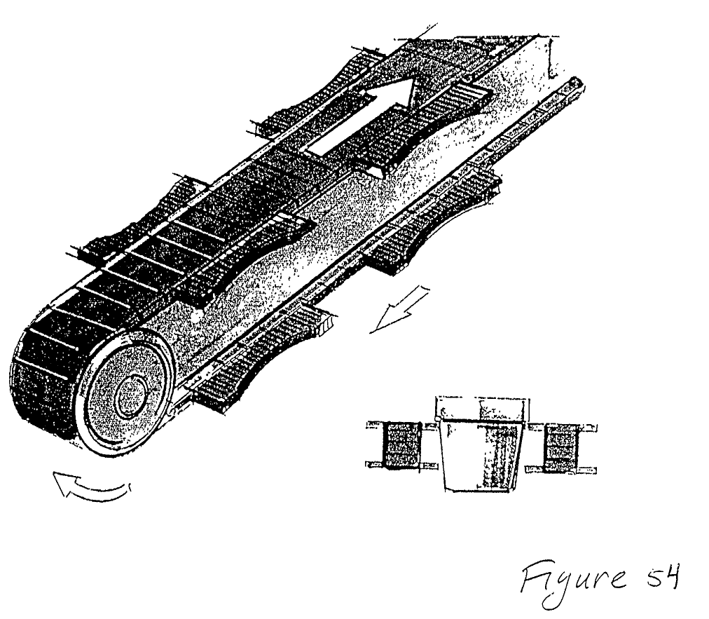

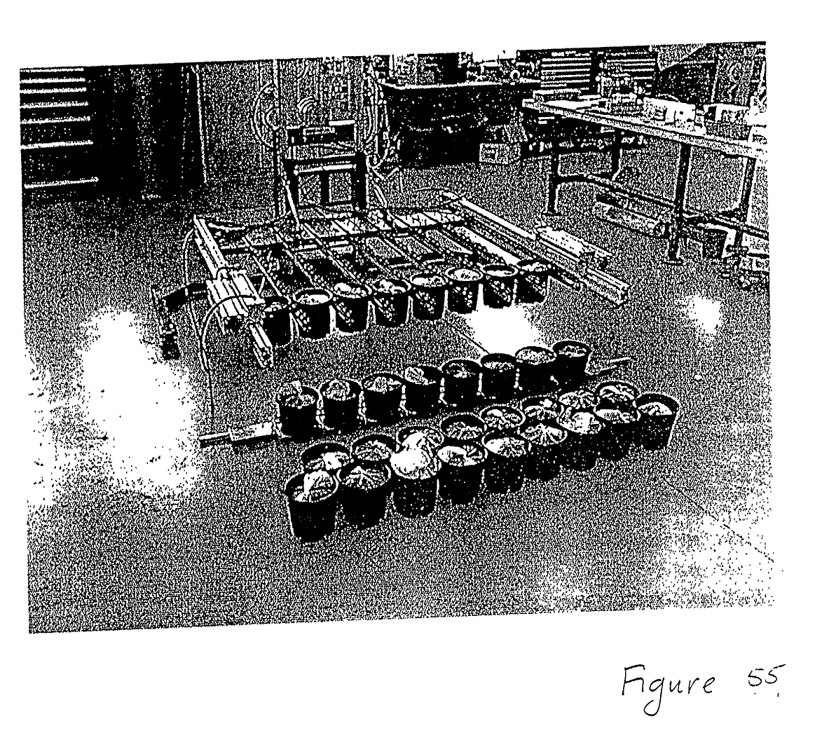

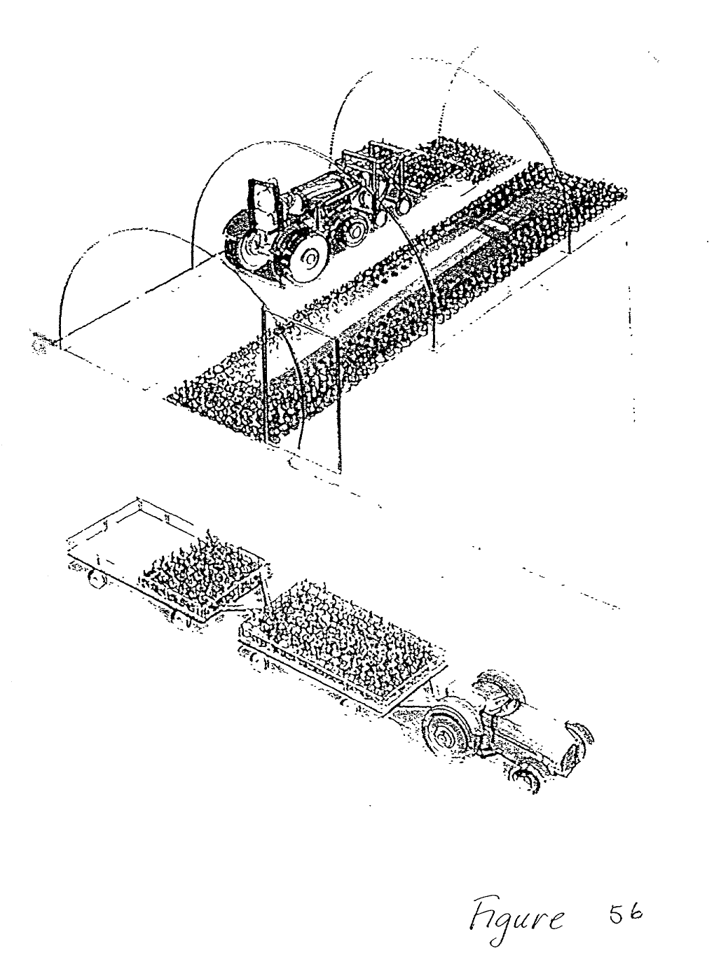

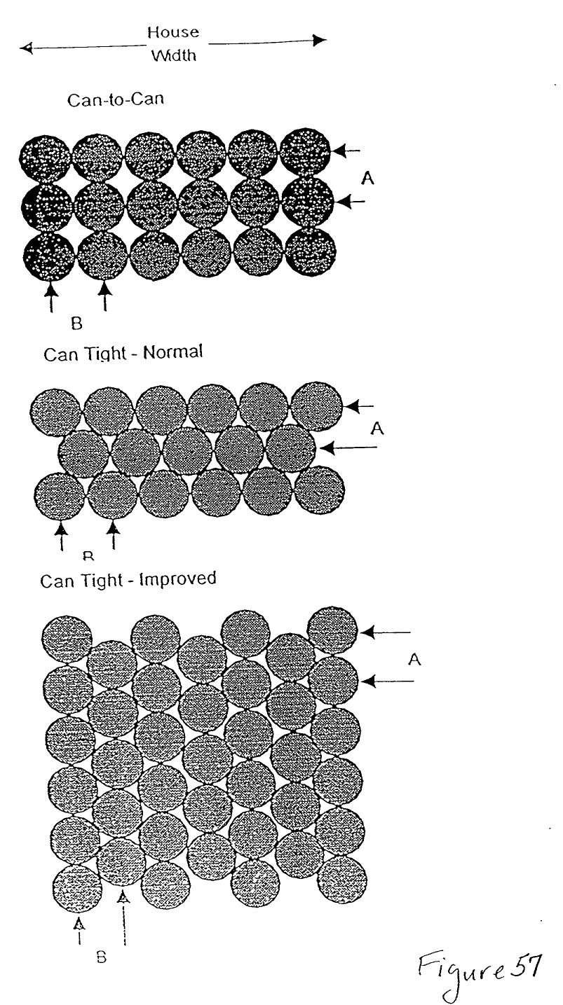

FIG. 53 shows an alternate design of a container-grabber that could be used to pick up and drop off can-to-can containers using the same idea of the butterfly grabber. The tines are pushed into the empty spaces between the pots and a simple push-pull mechanism (FIG. 53 illustrates manual activation) deploys or retracts the solid butterfly system thereby trapping the container and allowing the grabber to lift them and handle them. The grabber could thus be of any dimension and mounted to a tractor or other prime-mover (possibly even used as a hand tool) to deploy it in a variety of ways so as to maximize container-handling operations.

In a close-up view of the tool itself, it becomes evident that the tines guide a conveyor chain on their perimeter, which has a cast-urethane brush-attachment to support the container-lips. The containers are then indexed by a diameter backwards on the tine, until all tine space is filled. The hand-off form the grabber head occurs in continuous and synchronized manner, utilizing the lateral, longitudinal and vertical stroke of the head. The grabbers themselveswill lock the container in place prior to lifting it and translating as part of the grabber head. A detailed view of the system is shown in FIG. 66.

About 40 containers per minute, or about 2,400 containers per hour should be able to be moved. Assuming an 8 hour working day, a total of 20,000 containers per day per operator should be a reachable target. Note that these numbers were given for can-tight arrangements. For can-to-can, the numbers will most likely be higher, in the range of 25,000 per day. Note, that if properly set up, the operation could even by more efficient if the 3-minute portion of the cycle time to load and drop off containers onto and from the trailers is reduced through proper trailer placement, additional degrees of freedom to the tractor to operate the tool, etc.

The proposed concept of the system of the present invention brings with it a few implications in terms of several aspects of current operations within nurseries. In order to carefully detail these, we have provided a descriptive treatise of each implication as we see it today. This list will continue to be refined over time and as the concept is refined.

Growing-bed Layout

The current practice of placing containers in the open and on growing beds, leaves the nurserymen several options as to how to place their containers.

Depending on the container-size, plant-material and growing-season (plant-age) the grower can choose to utilize one of the can-to-can (cans set down side-by-side in rectangular fashion), can-tight (cans set down in shifted rectangular fashion) or even staggered/spaced (same as can tight, only with variable distance between containers to allow plant-material to grow laterally) arrangements. An exemplary configuration is shown in FIG. 66.

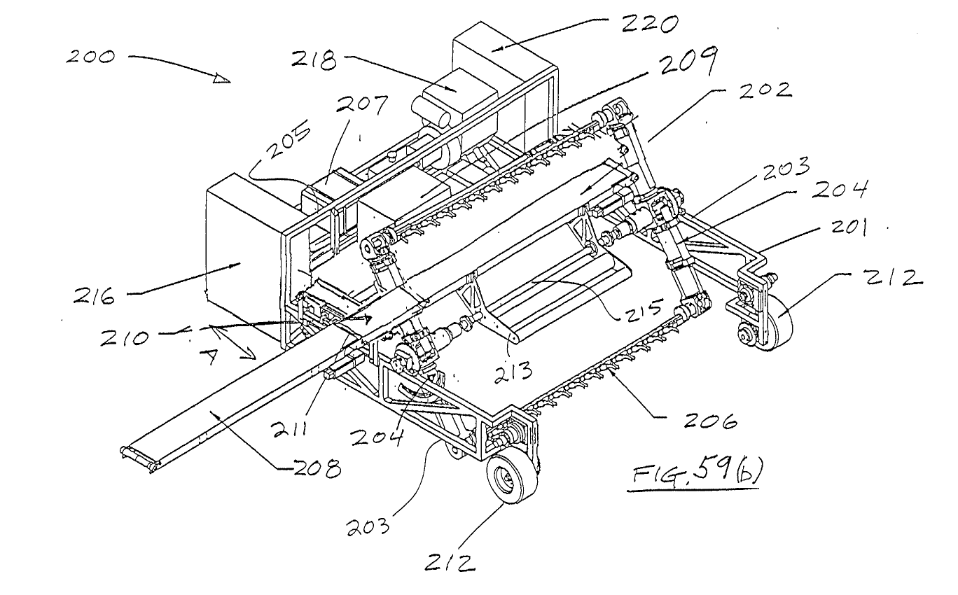

Should cans be placed can-to-can, the system of the present invention will have no trouble picking and placing these from/down-on a growing-bed. In the case of can-tight though, the system will have a preferred configuration of can-tight, so as to not leave any containers behind for manual pick-up (namely not can-tight-normal nor can-tight-improved). Rather than utilizing a setting that has odd-even-odd-even-etc. numbers of containers per row, the setting should be even-even-even-etc. so as to always fill up all tines with the same number of containers (need not but it maximizes productivity). The implied pattern that thus results for growing-beds is termed can-tight-modified and is shown in FIG. 58.

As compared to can-to-can the relative fill-factor per fixed bed-size, the relative increase in containers per square inch of growing bed is tabulated below—notice that even though can-tight-modified is not as good as can-tight-improved, it is still equivalent to can-tight-normal the way most growers set up their beds if they choose to stagger them can-tight!

| | Can | Can | Can |
|---|---|---|---|
| Can-to-Can | Tight-Normal | Tight-Improved | Tight-Modified |
| 100% | 12.85% | 15.47% | 12.90% |

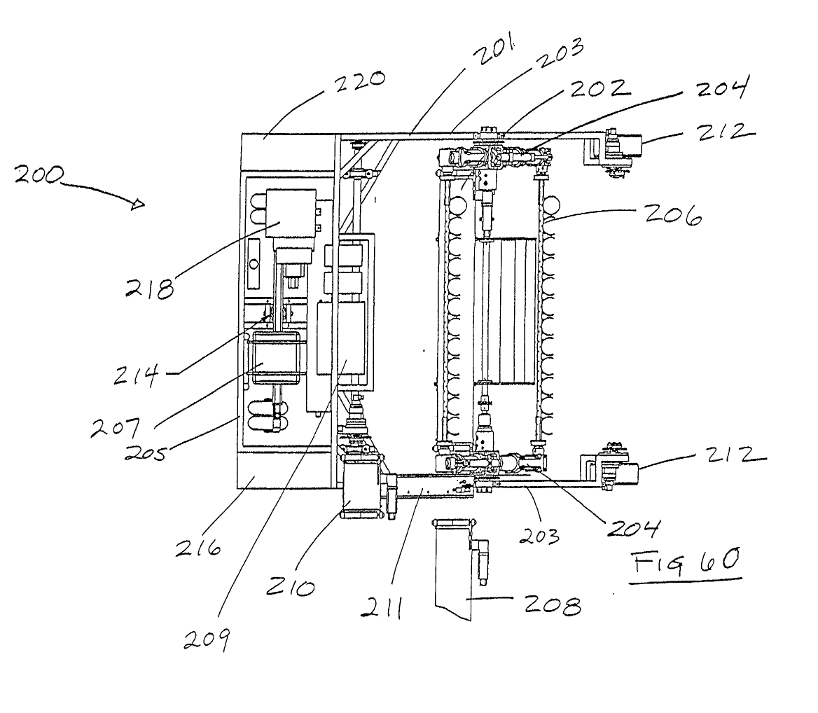

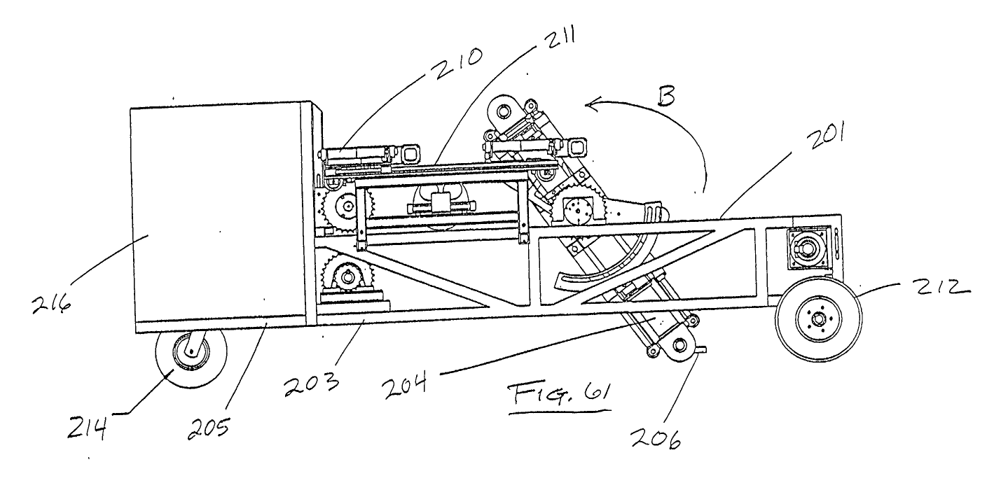

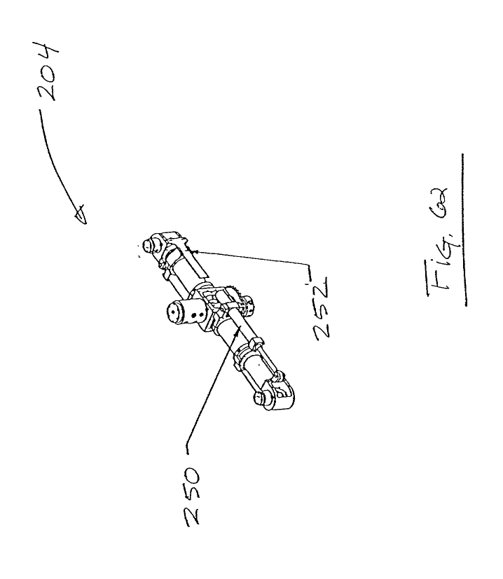

FIGS. 59-61 illustrate another embodiment of the container handling system 200 of the present invention wherein the container handling system 200 is self-propelled. The container handling system 200 comprises a frame 201, a transfer conveyor 202, telescoping arm assemblies 204, a grabber head assembly 206, a trailer conveyor 208, a slide conveyor 210, drive wheels 212, a caster wheel 214, a control enclosure 216, a power source assembly 218 and a power distribution enclosure 220. The frame 201 is a substantially U-shaped structure having two leg members 203 and an intermediate portion 205 that is fixedly connected to and extends between the two leg members 203. The intermediate portion 205 supports the power distribution enclosure 220, the power source assembly 218, the control enclosure 216, a hydraulic reservoir 209, a hydraulic accumulator (not shown), and a fuel tank 207 for the power source assembly 218. The power source assembly 218 is a gas engine with a hydraulic pump and generator (not shown). The gas engine, hydraulic pump and the generator may take the form of various conventional devices. For example, the gas engine may be a Briggs & Stratton model no. 950-G. Alternatively, the container handling system of the present invention may also be powered by an off-board power source such as a tractor with an auxiliary hydraulic supply. The power distribution enclosure 220 contains all the circuit breakers, relays, contactors, fuses and other electronics necessary for the container handling system 200 of the present invention, which are conventional. The control enclosure 216 houses all of the controls needed for the container handling system 220 of the present invention such as the motion controllers and control computer. The control computer is an Allen Bradley SLC/5 model 505 programmable logic controller (PLC). The ten axes of motion are position controlled via two Delta Computer Systems RMC series controllers (e.g. RMC-Q3-ENET, RMC-M2-ENET). The control enclosure 216 also houses safety circuitry, the ethernet-hub, power source gages (e.g. Tachometer, oil pressure gage, temperature gage, fuel gage). All of the system sensors signals are terminated and processed by either the motion controllers or control computer in the control enclosure 216.

The drive wheels 212 are rotatably connected at the free ends of the two leg members 203. A caster wheel 214 is rotatably connected along the intermediate portion of the frame 201. The frame 201 may be made from a variety of metals such as mild steel based on its strength characteristics and its cost.

The container handling system 220 of the present invention has a three-part conveyor system comprising the trailer conveyor 208, the transfer conveyor 202 and the slide conveyor 210. The trailer conveyor 208 is fixedly connected at its proximal end to one of the leg members 203 of the frame 201 using any conventional fastening means such as structural steel tubing having bolted connections. The slide conveyor 210 is slideably connected to the frame 201 such that the longitudinal axis of the slide conveyor 210 is parallel to the longitudinal axis of the trailer conveyor 208 when the slide conveyor 210 is in the inoperative position (FIG. 59a) and the longitudinal axis of the slide conveyor 210 is parallel to and aligned with the longitudinal axis of the trailer conveyor 208 when the slide conveyor 210 is in the operative position (FIG. 59b). The slide conveyor 210 is slideably attached to a elongated body 211 having rails along the length thereof and the elongated body 211 is fixedly attached to the frame 201. Thus, the slide conveyor 210 moves in the direction of arrow A. Specifically, the slide conveyor moves to the inoperative position, shown in FIG. 59a (i.e. towards the control enclosure) to allow the grabber head assembly 206 to rotate about the longitudinal axis of the central rod 215 such that the telescoping arm assemblies 204 and grabbers 280 are able to either pick-up or drop-off containers on the transfer conveyor 202, as described in further detail below. The slide conveyor 210 moves to the operative position (FIG. 59b) to allow containers to either be conveyed from or to the transfer conveyor 202. The transfer conveyor 202 is an elongated substantially flat member that is fixedly attached to a second frame member 213 using conventional fastening means. The second frame member 213 is fixedly attached to center rod 215 such that the transfer conveyor 202 does not move relative to the second frame 213 and the frame 201. When the slide conveyor 210 is in the operative position (FIG. 59b), the trailer conveyor 208, the slide conveyor 210 and the transfer conveyor 202 form a substantially continuous planar surface. The slide conveyor 210, the trailer conveyor 208 and the transfer conveyor 202 may take the form of any conventional conveyors that use crowned rollers. The second frame 213 is sized and proportioned such that it is counterbalanced with the transfer conveyor 202.

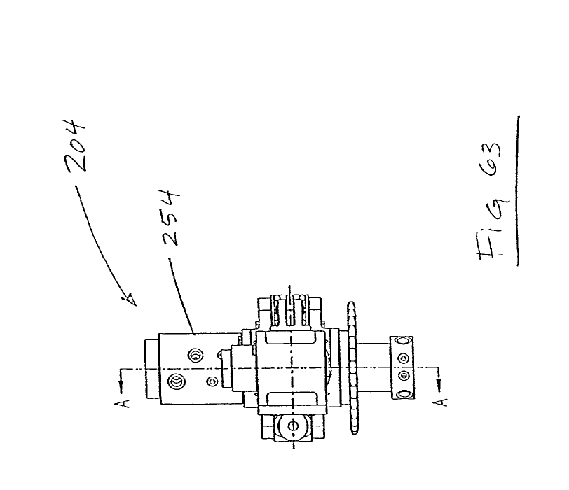

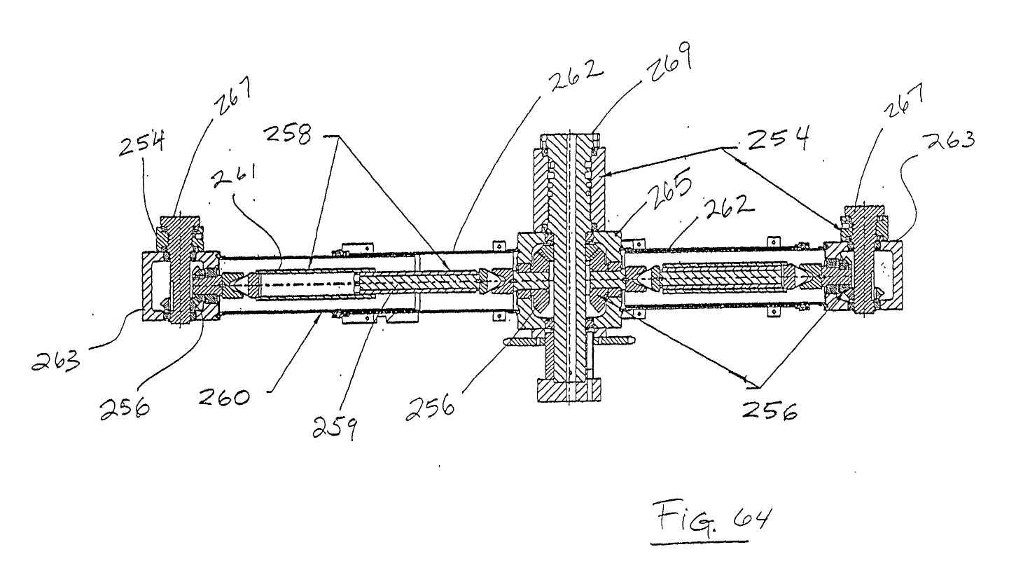

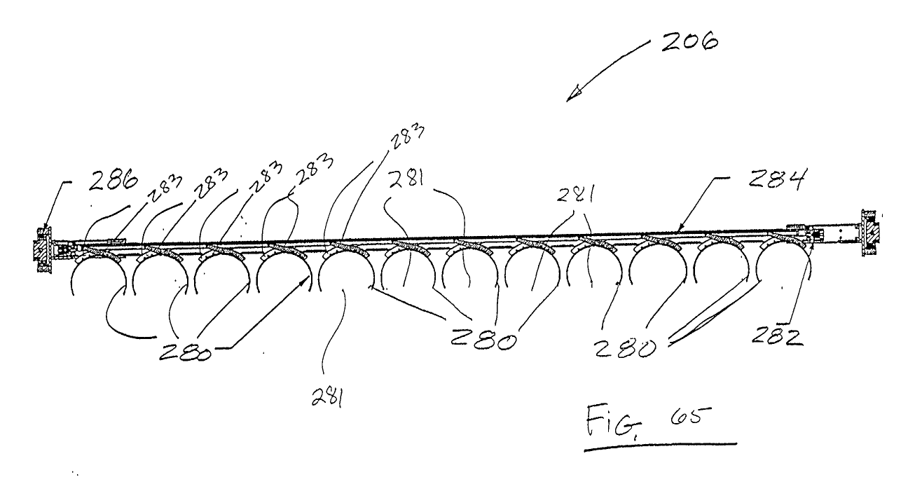

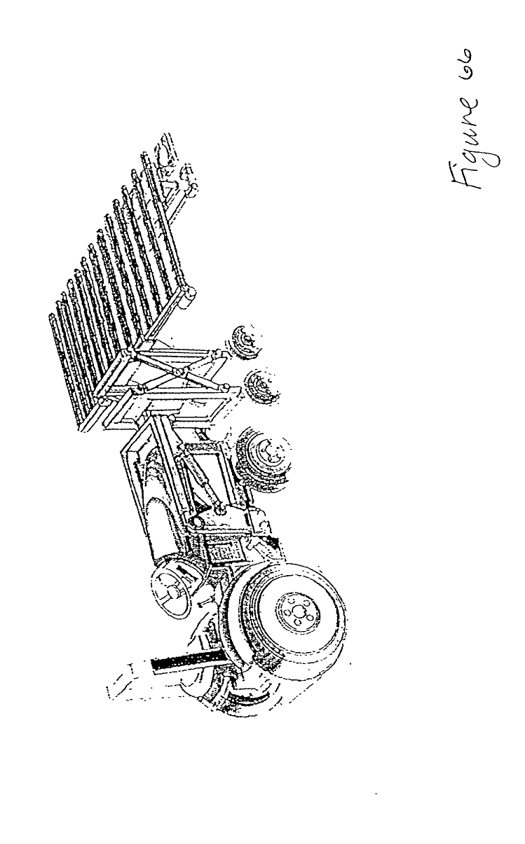

FIGS. 62-64 illustrate one of the telescoping arm assemblies 204 of the container handling system 200 of the present invention shown in FIG. 59a. The telescoping arm assemblies 204 are rotatably connected to the leg members 203 of the frame 201 at the shaft 269 such that the telescoping arm assemblies 204 rotate about the longitudinal axis of the central rod 215. Each of the telescoping arm assembly 204 comprises a hydraulic actuating cylinder assembly 250, an anti-rotation assembly 252, hydraulic slip rings 254, miter gears 256, telescoping splined alignment shafts 258, a telescoping tube 260, a stationary tube 262, drive housing 265 and idler housings 263.

The hydraulic actuating cylinder assembly 250 may take the form of any hydraulic actuating cylinder such as a Parker 1.5 inch bore cylinder with integral LDT position feedback. Alternatively, the hydraulic actuating cylinder assembly 250 could also be an electric linear actuator. The hydraulic actuating cylinder assembly 250 is fixedly connected to the telescoping tube 260 at one of its ends and also fixedly connected to the stationary tube 262 at the other of its ends such that the telescoping tube 260 may extend from and retract into the stationary tube 262. The anti-rotation assembly 252 is a substantially T-shaped plate having a bronze bearing and is fixedly connected to the idler housing 263 and the stationary tube 262. The anti-rotational assembly 252 may be made from metal. The anti-rotational assembly 252 prevents the grabber head 206 from rotating about its longitudinal axis such that the grabber head assembly 206 remains horizontal.

Each of the hydraulic slip rings 254 use HPS O-rings and Teflon guide rings and are attached to the idler housing 263 and drive housing 265 using anti-rotation tabs on the hydraulic slip ring housing and shoulder bolts on the housings 263 and 265. The idler housing 263 provides the structure necessary for transfer of loads (e.g. moments and forces) and hold bearings and shafts that are required for the miter gears 256. The miter gears 256 in the idler housing 263 and drive housing 265 ensure that the grabbers 280 always remain horizontal with respect to the ground such that the grabbers 280 may receive the containers. The miter gears 256 have a 1:1 ratio. Thus, when the miter gears 256 in the drive housing 265 rotate 10 degrees, the miter gears 256 in each of the idler housings 263 also rotate 10 degrees and the grabber head assemblies 204, which are connected to shaft 267, are also rotated.

The telescoping alignment shafts 258 are connected to the idler housing 263 at the ends thereof. The splines of the male shaft 259 mates with the splines of the female shaft 261 providing for the shafts 259 and 261 to slide relative to one another along the longitudinal axes thereof. The telescoping tube 260 and the stationary tube 262 are substantially cylindrical components. The stationary tube 262 remains stationary while the telescoping tube 260, which is fixedly connected to the exterior shaft 261 is able to move in the direction of its longitudinal axis. Each of above-mentioned components of the telescoping arm assemblies 204 is made from aluminum. Aluminum was chosen due to its low weight.

FIG. 65 illustrates the grabber head assembly 206 of the container handling system 200 of the present invention shown in FIG. 59a. Each of the grabber head assemblies 206 comprises a plurality of grabbers 280, a hydraulic actuating cylinder 282, four grabber interlinks 284 and a flexible coupling 286 connected at each end of the interlink 284. Each of the grabbers 280 may comprise a semi-circular aluminum structure having two arms defining an opening 281 and friction material lining the interior surface of the grabber arms. The friction material may take the form of an anti-skid material that is commonly placed on stair steps and can be purchased from 3M Corporation, Minneapolis, Minn. Each of the grabbers arms are attached to one interlinks 284 by a grabber pin resulting in each of the arms of the grabbers 280 being able to pivot relative to the pin such that the opening 281 of the grabber 280 increases and decrease and the container is gripped.

Each of the interlinks 284 may take the form of an extruded aluminum bar with precision holes for receiving each grabber pin. Each of the grabbers 280 have a lever 283 attached to the exterior surface of one of the grabber arms and connected to the hydraulic actuating cylinder 282 resulting in two levers 283 being connected to one grabber 280. Each lever is also connected to one of the interlinks 284. The levers 283 are moved from an open to a closed position by the hydraulic actuating cylinder 282 resulting in two interlinks 284 moving the grabber arms. When the interlinks 284 move the levers 283 from the opened position to the closed position, each lever 283 moves the attached grabber arm towards the other grabber arm and the opening 281 of the grabber 280 is decreased and the container is gripped. It takes two interlinks 283 to move one grabber 280 to the closed position. In this embodiment, four interlinks are used Two interlinks are attached to the arms of alternative grabbers. This enables alternative grabbers to open and close independently of the other grabbers. The ends of the interlink 284 are fixedly connected to the idler housings 263 of the telescoping arm assemblies 204 by the flexible coupling 286 allowing for minor variations in the position of the hydraulic cylinder. The flexible coupling 286 may be a two axis gimbal fabricated from stainless steel and utilizes bronze bushings for bearing surfaces.

The hydraulic actuating cylinders 282 use closed-loop position control. The hydraulic cylinders 282 have an integral LDT (i.e. magneto restrictive device) for position feedback. The motion controller (i.e. RMC-M2-ENET) uses this position feedback device to control the proportional flow hydraulic valve via an analog signal. The motion of the hydraulic actuating cylinder 282 is synchronized and coordinated via programming to execute appropriate motions for container pick up or placement in the field. The grabbers cylinders (i.e. single acting) are actuated by solenoid operated hydraulic valves via discrete (i.e. on/off) signals from the PLC (programmable logic controller). It is important to note that all of the hydraulic actuation could be easily replaced with electric actuation.

When picking up containers in the field, the container handling system 200 transverses the length of a field with containers. Specifically, the drive wheels 212 and the caster wheel 214 are rotated by the power of the gas engine in a conventional manner. A trailer (not shown) moves alongside the container handling system 200 such that the trailer conveyor 208 extends over the trailer bed. As the container system 200 approaches the containers in the field, the telescoping arm assemblies 204 rotate about the central rod 215 thus, rotating the grabber head assemblies 206 in the direction of arrow B, which is parallel to and around the longitudinal axis of the central rod 215. The position of the individual grabbers 280 do not change (i.e., the individual grabbers 280 remain parallel with the ground). As one of the grabber head assemblies 206 moves from the upper position to the lower position, the grabbers 280 receive the containers therein and the sensors signal the hydraulic actuating cylinder 283 to close the lever 283 and thus, decrease the opening. This results in the containers being firmly grasped by the grabbers 280. Once the containers are received by the grabbers 280, the grabber head assemblies 206 moves to the upper position where the containers are place on the transfer conveyor 202, the lever 283 is moved to the open position and the containers are thereby released and allowed to be conveyed to the slide conveyor 210 and then to the trailer conveyor 208 where they are transported to the trailer bed. Prior to the containers being transferred from the transfer conveyor 202 to the slide conveyor 210, the telescoping arm assembly 204 must extend the grabber head 206 such that it will clear the trailer conveyor 208. Once the telescoping assembly 204 rotates below the transfer conveyor 202 and the slide conveyor 210, the slide conveyor 210 is aligned with the transfer conveyor 202 and the containers are transferred to the trailer conveyor 208 and then to the trailer bed. After the containers leave the slide conveyor 210, the slide conveyor 210 slides back to the inoperative position such that the grabber head assembly 206 and the telescoping arm assembly 204 can rotate substantially 180 degrees in the B direction and the second set of grabbers 280 of the grabber head assembly 206 can be loaded and the above process can be repeated. The above processes may be repeated continuously until all the containers are transferred from the ground to the trailer bed.

In addition to the container handling system 200 being used to picking up containers and transferring the containers to a trailer, the container handling system 200 of the present invention may also be used to transfer containers from a trailer to the ground by essentially operating the container handling system 200 in reverse. Specifically, the containers on the trailer conveyor 208 will be moved along the trailer conveyor 208 to the sliding conveyor 210 in the operative position (FIG. 59b) and onto the transfer conveyor 202. While the containers are being moved along the conveyors 208, 210 and 202, the grabber head assembly 206 will be in the extended position (FIG. 59b) such that the containers can move along the three aligned conveyors. The sliding conveyor 210 will then move from the operative position (FIG. 59b) to the inoperative position (FIG. 59a) and the grabber head assembly 206 will move from the extended position (FIG. 59b) to the retracted position (FIG. 59a). In the retracted position, the grabbers 280 will receive the containers within the grabber openings 281 and then the levers 283 will move from the open to the closed position resulting in the grabbers gripping the containers therein. The grabber head assembly 206 will then rotate about the longitudinal axis of the central rod 213 and the grabbers 280 gripping the containers will be rotated to the ground, thus transporting the containers from the transfer conveyor 202 to the ground. Once the containers are firmly on the ground the lever 283 will move from the closed position to the opened position and the containers will be released. While the grabbers 280 with the containers is rotated to the ground, the second set of grabbers 280 which are empty is being rotated up to the transfer conveyor to load another set of containers therein. Before the empty set of grabbers 280 can be reloaded with containers, the sliding conveyor 210 must be moved from the operative position to the inoperative position.

The system uses analog IR sensors (e.g. BANNER Omni-beam IR sensors with a range of 3-18 inches) to determine the position of the containers at the end of each row. These sensed positions are used to infer the position of the row of containers with respect to the container handling system 200 and grabber head assembly 206. The drive wheels 212 are command to move based on this row position information in order to line up the grabbers 280 with the row of containers.

The apparatus and methods of the present invention may be used with a variety of sized containers and objects. Furthermore, the apparatus and methods of the present invention may be used to transport containers in a variety of growing bed layouts such as can-to-can, can-tight (improved and modified) and even staggered/spaced container configurations that allow for the plant to grow laterally, as illustrated in FIGS. 57 and 58 and described above.

Although the present invention has been described in conjunction with the above described embodiment thereof, it is expected that many modifications and variations will be developed. This disclosure and the following claims are intended to cover all such modifications and variations.

1. An apparatus for transferring objects comprising:
a grabber assembly having at least one grabber for holding objects to be transferred;
a carriage along which the grabber assembly travels;
a sensing device for determining the relative geometric positions of the objects to be transferred;
a positioning unit for positioning the grabber in up to four degrees of motion in response to the determined geometric positions; and,
at least one power source for driving the travel of the grabber assembly and the positioning of the grabber.

2. The apparatus of claim 1 wherein the positioning unit comprises:
an X-axis assembly for positioning the grabber along an X-axis;
a Y-axis assembly for positioning the grabber along a Y-axis;
a Z-axis assembly for positioning the grabber along a Z-axis; and,
a pivotal assembly for positioning the grabber at an angle θ.

3. The apparatus of claim 2 wherein the X-axis assembly comprises:
a first frame;
a second frame;
one or more rails connected to the second frame and lying on or parallel to an X-axis;
said first frame being mounted for travel on the one or more X-axis rails and being operatively connected to the grabber.

4. The apparatus of claim 3 wherein the positioning unit comprises:
a third frame;
one or more rails connected to the third frame and lying on or parallel to a Y-axis; and,
said second frame mounted for travel on the one or more Y-axis rails.

5. The apparatus of claim 4 wherein the positioning unit further comprises a fourth frame and the Z-axis assembly comprises:
one or more rails lying on or parallel to a Z-axis, the Z-axis rails being connected to the fourth frame;
one or more Z-axis adjusters mounted for travel on the one or more Z-axis rails.

6. The apparatus of claim 5 wherein the third frame has first and second ends and is mounted for pivotal motion about a pivotal axis, and wherein the pivotal assembly is comprised of:
two of said Z-axis rails;
two mounting members, one being pivotally connected to the first end of the third frame and the other being pivotally mounted to the second end of the third frame;
two of said Z-axis adjusters, each being connected to a different mounting member; and,
two cylinders, each being linked to a different Z-axis adjuster and each being operable at different rates and in different directions for selective non-uniform movement of one or both of the Z-axis adjusters along the Z-axis rails.

7. The apparatus of claim 2 wherein the X-axis assembly comprises:
one or more rails lying on or parallel to a X-axis; and,
one or more X-axis adjusters mounted for travel on the one or more X-axis rails;
said X-axis adjusters being operatively connected to the grabber.

8. The apparatus of claim 2 wherein the Y-axis assembly comprises:
one or more rails lying on or parallel to a Y-axis; and,
one or more Y-axis adjusters mounted for travel on the one or more Y-axis rails;
said Y-axis adjusters being operatively connected to the grabber.

9. The apparatus of claim 2 wherein the Z-axis assembly comprises:
one or more rails lying on or parallel to a Z-axis; and,
one or more Z-axis adjusters mounted for travel on the one or more Z-axis rails;
said Z-axis adjusters being operatively connected to the grabber.

10. The apparatus of claim 2 wherein the pivotal assembly comprises:
a frame having first and second ends and being mounted for pivotal motion about a pivotal axis, the frame being operatively connected to the grabber such that movement of the frame about the pivotal axis is translated to the grabber;
at least two extension members for moving the frame about the pivotal axis, one member being connected to the first end of the frame and the other extension member being connected to the second end of the frame;
means for moving one or both of the extension members at one or both of a rate and in a direction that differs from the other of the at least two members.

11. The apparatus of claim 1 wherein the apparatus is a self propelled vehicle further comprising at least one of each of a drive motor, a drive train, wheels and control components for steering the apparatus.

12. The apparatus of claim 1 wherein the apparatus is an accessory for releasable attachment to an independently powered vehicle.

13. The apparatus of claim 1 wherein the power source is a gas-powered motor and the apparatus further comprises power conversion components for converting gas power to one or both of electrical power and hydraulic power.

14. The apparatus of claim 13 further comprising a second source of power for powering the positioning unit.

15. The apparatus of claim 14 wherein the second source of power is hydraulic power.

16. The apparatus of claim 1 wherein the carriage comprises:
opposing frame sections spaced from each other, each frame section having a guide rail mounted thereon to define a path, wherein the path includes a first elevated surface, an inclined surface, and a second lower surface;
a drive motor; and,
drive chains powered by the drive motor associated with each guide rail.

17. The apparatus of claim 16 wherein each frame section comprises an inner frame and an outer frame defining a space therebetween, and the carriage further comprises:
a drive rod spanning the space between opposing frame sections;
the drive motor operatively connected to the drive rod;
a plurality of chain sprockets mounted in the space between the inner and outer frame sections along the length of each path for engagement with the drive chains; and,
a channel for housing connections to the power supply.

18. The apparatus of claim 16 wherein the grabber assembly comprises:
opposing travel arms, each having forward ends and rear ends;
roller members mounted on each travel arm and driven by the drive chain of the carrier for travel along the path thereof;
a grabber rail positioned proximate to the forward ends of the travel arms; and,
a plurality of grabbers mounted on the grabber rail.

19. The apparatus of claim 18 wherein the grabbers have an open position and a closed position for grasping objects to be transferred, the grabbers being operatively connected to the power source for effecting the open or the closed positions.

20. The apparatus of claim 18 wherein the grabbers are arcuate in structure.

21. The apparatus of claim 18 wherein the grabbers are forked in configuration.

22. The apparatus of claim 18 wherein the grabbers are in the form of pincers.

23. The apparatus of claim 18 wherein the grabbers define opposing butterfly wings, each wing being movable into an open position and a closed position, each wing having an arcuate recess in facing relationship to the arcuate recess of the opposing wing to define therebetween a space for positioning the object to be transferred; the grabbers being operatively connected to the power source for moving the wings into the open or the closed positions.

24. The apparatus of claim 18 wherein the grabbers are fixed tines configured for supporting tapered objects and rimmed objects.

25. The apparatus of claim 18 wherein the positioning unit is mounted on the forward ends of the travel arms and the grabber rail is mounted on the positioning unit and is structured for motion relative to the travel arms.

26. The apparatus of claim 1 wherein the sensing device is mounted on a forward end of the apparatus for capturing the orientation of objects to be transferred along X, Y and Z axes and at an angle θ relative to a selected frame of reference.

27. The apparatus of claim 26 wherein the sensing device is a two-dimensional laser scanner.

28. The apparatus of claim 26 wherein the sensing device receives positional signals from the sensed objects and transfers such signals to a processing unit for determination of the geometric positions of the sensed objects and the movement of the positioning unit necessary for alignment of the grabbers with the objects.

29. The apparatus of claim 1 further comprising a conveyor system for receiving and transferring objects.

30. The apparatus of claim 29 wherein there are at least two conveyor portions, one positioned proximate the forward end of the apparatus and another positioned on a side of the apparatus.

31. The apparatus of claim 30 wherein there is a third conveyor positioned at the rear of the apparatus.

32. The apparatus of claim 30 wherein the conveyor system includes a spacer device mounted proximate the side conveyor for selective movement onto or away from the side conveyor, the spacer device having a plurality of spaced tabs extending outwardly therefrom such that, when moved onto the side conveyor, the tabs define spaces for receiving individual objects to be transferred.

33. The apparatus of claim 30 wherein the side conveyor is pivotally mounted at a junction between the forward and side conveyors to allow the side conveyor to be pivoted to a desired position relative to the forward conveyor.

34. The apparatus of claim 30 wherein there are a plurality of grabbers and the apparatus further comprises an indexer for optional mounting at the junction between the forward and side conveyors, the indexer configured for conveying objects around a corner when the side conveyor is in a non linear position relative to the forward conveyor.

35. The apparatus of claim 34 wherein the indexer is further configured for aligning the objects transferred from the side conveyor to the forward conveyor for engagement with the grabbers.

36. The apparatus of claim 34 wherein the indexer is comprised of:
a plate member defining a plurality of spaces configured for receiving objects to be transferred;
a gear assembly for advancing the receiving spaces;
means for driving the gear assembly.

37. The apparatus of claim 34 wherein the plate member includes upper and lower circular plates and the receiving spaces are radially spaced about the circumference of each plate.

38. The apparatus of claim 37 wherein the driving means is a motor operatively connected to the gear assembly for rotating the plates about a central axis.

39. The apparatus of claim 34 wherein the receiving spaces are concave in shape.

40. The apparatus of claim 1 wherein the sensing device is an imaging device.

41. The apparatus of claim 40 wherein the imaging device is a stereo camera.

42. The apparatus of claim 40 wherein the imaging device is a two-dimensional laser scanner.

43. A system for transferring objects from one location to another comprising:
a vehicle having a power source;
a drive subsystem;
a sensing subsystem for determining the geometric orientation of the objects;
a grabber subsystem for grasping the objects, including a positioning assembly for aligning the grabber subsystem with the objects in response to the determined geometric positions;
a carriage subsystem for moving the grabber subsystem; and,
a conveyor subsystem for conveying the objects.
